(19) United States
(12) Patent Application Publication
(10) Pub. No.: US 2026/0247069 A1
(43) Pub. Date: Aug. 20, 2026

(54) SOUND SIGNAL OUTPUT SYSTEM AND SOUND SIGNAL OUTPUT METHOD

(71) Applicant: NTT, Inc., Tokyo (JP)

(72) Inventors: Tatsuya KAKO, Musashino-shi, Tokyo (JP); Hironobu CHIBA, Musashino-shi, Tokyo (JP); Kenichi NOGUCHI, Musashino-shi, Tokyo (JP); Akira NAKAYAMA, Musashino-shi, Tokyo (JP)

(73) Assignee: NTT, Inc., Tokyo (JP)

(21) Appl. No.: 19/159,331

(22) PCT Filed: Mar. 2, 2023
(86) PCT No.: PCT/JP2023/007799

§ 371 Date: Aug. 25, 2025

(51) Int. Cl. H04R 1/34; H04R 1/26; H04R 1/30; H04R 3/12

(52) U.S. Cl. CPC H04R 1/347; H04R 1/26; H04R 1/30; H04R 3/12

(57) ABSTRACT

A sound signal output system includes a sound signal output apparatus disposed near a first area for warning and a control unit that controls sound signal emission. Each sound signal output apparatus is assigned a sub-area including a first area and a second area, and includes a reflector and a driver unit. When a sound signal AC1 is emitted from one side of the driver unit and a sound signal AC2 is emitted from the other side, the attenuation rate of AC1 at a second point Q2 with reference to a first point Q1 is configured to be equal to or less than the attenuation rate due to air propagation between Q1 and Q2, or the attenuation amount of AC1 at Q2 with reference to Q1 is configured to be equal to or greater than the attenuation amount due to air propagation between Q1 and Q2.

### TECHNICAL FIELD

The present invention relates to a sound signal output system and a technique for suppressing sound leakage to the surroundings.

### BACKGROUND ART

Conventionally, there are techniques of voice guidance signs such as a voice guidance plate, a tactile guidance plate, and a voice sign as a technique of guiding a subject by voice.

### CITATION LIST

### Non Patent Literature

Non Patent Literature 1: “Onsei Annai Sain No Shikumi Tou Ni Tsuite (in Japanese) About plot of a sound information signature.”, Hamamatsu city, [searched on Feb. 13, 2023], the Internet <https://www.city.hamamatsu.shizuoka.jp/tochi/city/toshikai/s ign/3.html>

### SUMMARY OF INVENTION

### Technical Problem

In a case where the technique of the voice guidance sign described above is applied and a user is notified of a dangerous place using a speaker, it is necessary to present the dangerous place by a voice or an alarm sound from the speaker.

However, in the above-described method, it is necessary to recognize where a dangerous place is by a notice at the feet or the surroundings in order for a subject to grasp the danger to actually respond. In addition, in order to take an appropriate action, it is necessary to listen to a voice of the voice guidance sign together with recognition of a dangerous place and grasp the instruction content. On the other hand, in a case where the above-described method is adopted, the sound of the voice guidance sign is heard uniformly even for a person (human) who is not necessarily in a dangerous place or who has a predetermined danger but having a low necessity to take a response action. For a such a non-target human, there is a problem that the voice may cause discomfort and noise damage.

The present disclosure has been made in view of such a point, and it is an object to provide a technique of causing only a subject who is desired to take a predetermined action to listen to a voice.

### Solution to Problem

A sound signal output system of the present disclosure is a sound signal output system for use in a predetermined area including a first area for indicating a warning and a second area adjacent to the first area and having a lower necessity for indicating the warning than the first area, the sound signal output system including: a plurality of sound signal output apparatuses that is disposed in the first area or in a vicinity of the first area and emits a sound signal; and a control unit that controls emission by the plurality of sound signal output apparatuses using a sound source corresponding to the warning. Each sound signal output apparatuses is allocated with a different sub-area in a case where the predetermined area includes a plurality of sub-areas including a first sub-area in the first area and a second sub-area adjacent to the first sub-area and in the second area, and includes a concave reflector that has a rotational paraboloid or a surface approximate to the rotational paraboloid inside, and a first driver unit that is disposed inside the reflector. A sound signal emitted from the first driver unit to one side is set as a first sound signal, a sound signal emitted from the first driver unit to the other side is set as a second sound signal, when the first sound signal is emitted from the one side of the first driver unit and the second sound signal is emitted from the other side of the first driver unit, an attenuation rate of the first sound signal at a second point in the second sub-area of the allocated sub-area, the second point being a point farther from the sound signal output apparatuses than a first point with reference to the first point in the first sub-area of the allocated sub-area, the first point being a predetermined point where the first sound signal reaches is configured to be less than or equal to a predetermined value smaller than an attenuation rate of a sound signal due to air propagation at the second point with reference to the first point. Alternatively, an attenuation amount of the first sound signal at the second point with reference to the first point is configured to be equal to or more than a predetermined value larger than an attenuation amount of the sound signal due to air propagation at the second point with reference to the first point.

### Advantageous Effects of Invention

With this configuration, sound leakage to the surroundings can be suppressed, and thus, it is possible to cause only a subject who is desired to take a predetermined action to listen to a predetermined sound signal.

### BRIEF DESCRIPTION OF DRAWINGS

FIG. 1 is a transparent front view illustrating a configuration of a sound signal output apparatuses of a first embodiment.

FIG. 2 is a transparent plan view illustrating a configuration of a sound signal output apparatuses of the first embodiment.

FIG. 3 is a cross-sectional view taken along line 1-1 of FIG. 1.

FIG. 4 is a cross-sectional view taken along line 2-2 of FIG. 2.

FIG. 5 is a conceptual diagram for illustrating arrangement of sound holes.

FIG. 6 is a conceptual diagram for describing a relationship between a rotational paraboloid and a focal point.

FIG. 7A is a conceptual diagram for describing a traveling direction of a sound signal in a case where a driver unit is disposed at a focal point of a rotational paraboloid. FIG. 7B is a conceptual diagram for describing a traveling direction of a sound signal in a case where a driver unit is not disposed at a focal point of a rotational paraboloid.

FIG. 8A is a conceptual diagram for illustrating a configuration in which a horn is attached to a driver unit. FIG. 8B is a conceptual diagram for illustrating an arrangement configuration of a sound signal output apparatuses of the first embodiment.

FIG. 9A is a block diagram for illustrating a functional configuration in which a signal is supplied to a driver unit. FIG. 9B is a diagram illustrating a sound pressure level at a measurement point.

FIGS. 10A and 10B are graphs for illustrating directional characteristics of a sound signal output apparatuses.

FIGS. 11A and 11B are graphs for illustrating directional characteristics of a sound signal output apparatus.

FIG. 12 is a graph for illustrating directional characteristics of a sound signal output apparatus.

FIGS. 13A and 13B are graphs for illustrating frequency characteristics of a sound signal output apparatus.

FIGS. 14A and 14B are graphs for illustrating frequency characteristics of a sound signal output apparatus.

FIG. 15 is a graph for illustrating frequency characteristics of a sound signal output apparatus.

FIG. 16 is a front view for illustrating a modification example of arrangement of sound holes.

FIG. 17 is a front view for illustrating a modification example of arrangement of sound holes.

FIG. 18 is a transparent front view illustrating a configuration of a sound signal output apparatus of a modification example of the first embodiment.

FIG. 19 is a transparent plan view illustrating a configuration of a sound signal output apparatus of the modification example of the first embodiment.

FIG. 20A is a transparent plan view illustrating a configuration of a housing of the modification example of the first embodiment. FIG. 20B is a transparent front view illustrating a configuration of a housing of the modification example of the first embodiment. FIG. 20C is a bottom view illustrating a configuration of a housing of the modification example of the first embodiment.

FIG. 21 is a cross-sectional view taken along line 19-19 of FIG. 19.

FIGS. 22A and 22B are cross-sectional views for illustrating a configuration of a sound signal output apparatus of the modification example of the first embodiment.

FIG. 23 is a transparent front view illustrating a configuration of a sound signal output apparatus of a second embodiment.

FIG. 24 is a transparent plan view illustrating a configuration of a sound signal output apparatus of the second embodiment.

FIG. 25 is a transparent front view illustrating a configuration of a sound signal output apparatus of a modification example of the second embodiment.

FIG. 26 is a transparent front view illustrating a configuration of a sound signal output apparatus of the modification example of the second embodiment.

FIG. 27A is a graph for illustrating frequency characteristics of a sound signal measured on a cutout portion side. FIG. 27B is a graph for illustrating frequency characteristics of a sound signal measured on a side where a cutout portion is not provided.

FIG. 28A is a graph for illustrating frequency characteristics of a sound signal measured on a cutout portion side and on a side where a cutout portion is not provided. FIG. 28B is a graph for illustrating a difference in frequency characteristics of a sound signal due to a difference in cutout portion.

FIG. 29 is a transparent front view illustrating a configuration of a sound signal output apparatus of a third embodiment.

FIG. 30A is a block diagram illustrating a functional configuration in which a signal is supplied to a driver unit. FIG. 30B is a diagram illustrating a sound pressure level at a measurement point.

FIG. 31 is a block diagram for illustrating a functional configuration of a sound signal output system according to a fourth embodiment.

FIG. 32A is a view from above in a case where the sound signal output system of the fourth embodiment is applied to a railway station. FIG. 32B is a view of the railway station in FIG. 32A as viewed from a longitudinal direction of the platform.

FIG. 33A is a view from above in a case where the sound signal output system of the fourth embodiment is applied to a construction site on a roadside. FIG. 33B is a view of FIG. 33A as viewed from a roadside direction.

FIG. 34 is a view in which a predetermined area PL is simplified in order to describe a sub-area ST.

FIG. 35 is an image diagram illustrating that a sound signal reaches a second area T2.

FIG. 36 is a diagram illustrating a processing flow example of the sound signal output system according to the fourth embodiment.

FIG. 37 is a block diagram for illustrating a functional configuration of a sound signal output system according to a fifth embodiment.

FIG. 38A is a view illustrating a first area T′1 and a second area T′2 when FIG. 37 is viewed from an XZ plane.

FIG. 38A is a view illustrating a first area T′1 and a second area T′2 when FIG. 37 is viewed from a YZ plane.

FIG. 39 is a diagram illustrating a processing flow example of the sound signal output system according to the fifth embodiment.

FIG. 40 is a diagram illustrating another processing flow example of the sound signal output system according to the fifth embodiment.

### DESCRIPTION OF EMBODIMENTS

Hereinafter, embodiments of the present invention will be described with reference to the drawings. A sound signal output system according to embodiments of the present invention includes a sound signal output apparatus as described below. Various embodiments are conceivable for this sound signal output apparatus. Therefore, embodiments of the sound signal output apparatus used in the present system will be described as first to third embodiments. Then, the sound signal output system according to embodiments of the present invention will be described as fourth to fifth embodiments.

### First Embodiment

First, a first embodiment of the present invention will be described.

### <Configuration>

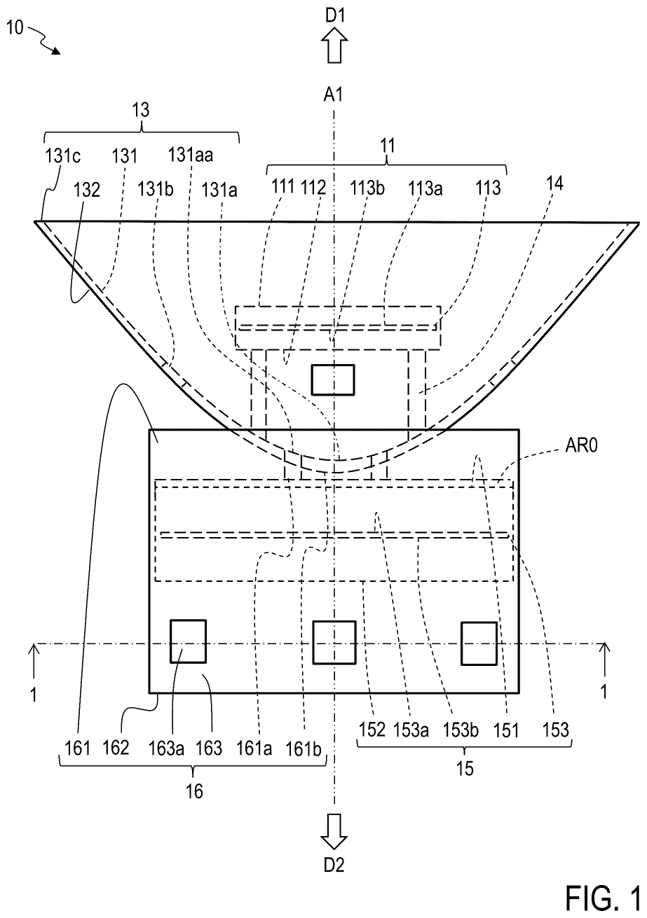

A sound signal output apparatus 10 of the present embodiment is a sound listening apparatus (for example, open-ear (open) earphones, headphones, an installation speaker, a built-in speaker, or the like) that is worn without sealing the ear canals of a user. As illustrated in FIGS. 1 to 4, the sound signal output apparatus 10 of the present embodiment includes a concave (for example, a parabolic) reflector 13 that has a rotational paraboloid or a surface approximate to the rotational paraboloid inside, driver units 11 and 15 (a speaker driver unit and a driver) that convert an output signal (an electric signal representing a sound signal) output from a reproduction apparatus into a sound signal and output the sound signal, a housing 16 that accommodates the driver unit 15 therein, and a support portion 14 for disposing the driver unit 11 inside the reflector 13.

### <Driver Unit 11 (First Driver Unit)>

In the present embodiment, the frequency band of the sound signal to be reproduced (reproduced sound signal) is divided into a high frequency band and a low frequency band, and the driver unit 11 emits the sound signal on the high frequency band side among the reproduced sound signals. That is, the driver unit 11 mainly handles a high-frequency sound signal among the reproduced sound signals. The output signal output from the reproduction apparatus is separated into a high frequency band signal on a high-frequency side and a low frequency band signal on a low-frequency side, which is lower than the high frequency band signal, and the separated high frequency band signal is input to the driver unit 11. Note that the frequency bands in which the level of the high frequency band signal and the level of the low frequency band signal are greater than or equal to a predetermined value may overlap each other or may not overlap each other. The driver unit 11 is an apparatus (apparatus having a speaker function) that emits (emits a sound of) a sound signal AC1 (first sound signal) based on an input high frequency band signal to one side (D1 direction side), and emits a sound signal AC2 (second sound signal) that is an antiphase signal (phase inversion signal) of the sound signal AC1 or an approximate signal of the antiphase signal to the other side (D2 direction side). That is, the sound signal emitted from the driver unit 11 to one side (D1 direction side) is referred to as the sound signal AC1 (first sound signal), and the sound signal emitted from the driver unit 11 to the other side (D2 direction side) is referred to as the sound signal AC2 (second sound signal). For example, the driver unit 11 is disposed on an axis A1 (axis) extending along the D1 direction or near the axis A1 (axis), and the sound signals AC1 and AC2 are emitted along the axis A1 (axis). For example, the driver unit 11 includes a diaphragm 113 that emits the sound signal AC1 from one surface 113a to the D1 direction side by vibration and emits the sound signal AC2 from the other surface 113b to the D2 direction side by the vibration (FIG. 1). For example, the diaphragm 113 is disposed on the axis A1 (axis) or near the axis A1 (axis). When the diaphragm 113 vibrates on the basis of the input high frequency band signal, the driver unit 11 of this example emits the sound signal AC1 from one-side surface 111 to the D1 direction side and emits the sound signal AC2 that is an antiphase signal of the sound signal AC1 or an approximate signal of the antiphase signal from the other side surface 112 to the D2 direction side. That is, the sound signal AC2 is secondarily emitted along with emission of the sound signal AC1. Note that the D2 direction (other side) is, for example, the opposite direction of the D1 direction (one side), but the D2 direction does not need to be strictly the opposite direction of the D1 direction, and the D2 direction is only required to be different from the D1 direction. The relationship between one side (D1 direction) and the other side (D2 direction) depends on the type and shape of the driver unit 11. In addition, depending on the type and shape of the driver unit 11, the sound signal AC2 may strictly be an antiphase signal of the sound signal AC1, or the sound signal AC2 may be an approximate signal of the antiphase signal of the sound signal AC1. For example, the approximate signal of the antiphase signal of the sound signal AC1 may be (1) a signal obtained by shifting a phase of the antiphase signal of the sound signal AC1, (2) a signal obtained by changing (amplifying or attenuating) an amplitude of the antiphase signal of the sound signal AC1, or (3) a signal obtained by shifting the phase of the antiphase signal of the sound signal AC1 and further changing the amplitude. A phase difference between the antiphase signal of the sound signal AC1 and the approximate signal thereof is desirably smaller than or equal to 51% of one period of the antiphase signal of the sound signal AC1. Examples of 51% include 1%, 3%, 5%, 10%, and 20%. In addition, a difference between the amplitude of the antiphase signal of the sound signal AC1 and the amplitude of the approximate signal thereof is desirably smaller than or equal to 52% of the amplitude of the antiphase signal of the sound signal AC1. Examples of 52% include 1%, 3%, 5%, 10%, and 20%. Note that examples of the type of the driver unit 11 include a dynamic type, a balanced armature type, a hybrid type of the dynamic type and the balanced armature type, and a capacitor type. In addition, the shapes of the driver unit 11 and the diaphragm 113 are not limited. In the present embodiment, for simplification of description, an example in which the outer shape of the driver unit 11 is a substantially cylindrical shape including both end surfaces and the diaphragm 113 is a substantially disk shape is described, but this does not limit the present invention. For example, the outer shape of the driver unit 11 may be a rectangular parallelepiped shape or the like, and the diaphragm 113 may be a dome shape or the like. In addition, examples of a sound signal are a sound such as music, a voice, a sound effect, and an environmental sound.

### <Driver Unit 15 (Second Driver Unit)>

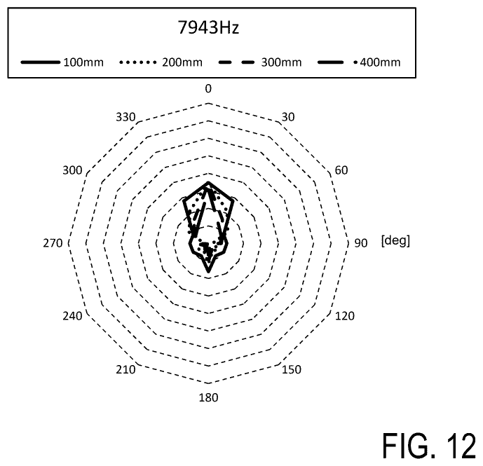

The driver unit 15 of the present embodiment is disposed on the D2 direction side of the driver unit 11. The driver unit 15 is larger in size than the driver unit 11 and emits the sound signal on the low frequency band side among the reproduced sound signals described above. That is, the driver unit 15 mainly handles a low-frequency sound signal among the reproduced sound signals. Thus, a low frequency sound pressure can be obtained as compared with a case where only the driver unit 11 is used. As described above, the low frequency band signal separated from the output signal is input to the driver unit 15, and the driver unit 15 is an apparatus (apparatus having a speaker function) that emits (emits a sound of) a sound signal AC3 (third sound signal) based on the input low frequency band signal to one side (D1 direction side), and emits a sound signal AC4 (fourth sound signal) that is an antiphase signal (phase inversion signal) of the sound signal AC3 or an approximate signal of the antiphase signal to the other side (D2 direction side). That is, the sound signal emitted from the driver unit 15 to one side (D1 direction side) is referred to as the sound signal AC3 (third sound signal), and the sound signal emitted from the driver unit 15 to the other side (D2 direction side) is referred to as the sound signal AC4 (fourth sound signal). For example, the driver unit 15 is disposed on the axis A1 (axis) or near the axis A1 (axis), and the sound signals AC3 and AC4 are emitted along the axis A1 (axis). The driver unit 15 includes a diaphragm 153 (second diaphragm) that emits the sound signal AC3 (third sound signal) from one surface 153a to the D1 direction side (one side) by vibration and emits the sound signal AC4 (fourth sound signal) from the other surface 153b to the D2 direction side (the other side) by the vibration (FIG. 12). For example, the diaphragm 153 is disposed on the axis A1 (axis) or near the axis A1 (axis). When the diaphragm 153 vibrates on the basis of the input low frequency band signal, the driver unit 15 of this example emits the sound signal AC3 from one-side surface 151 to the D1 direction side and emits the sound signal AC4 that is an antiphase signal of the sound signal AC3 or an approximate signal of the antiphase signal from the other side surface 152 to the D2 direction side. That is, the sound signal AC4 is secondarily emitted along with emission of the sound signal AC3. The sound signal AC3 is an in-phase signal of the sound signal AC1 or an approximate signal of the in-phase signal, and the sound signal AC4 is an in-phase signal of the sound signal AC2 or an approximate signal of the in-phase signal. Note that, depending on the type and shape of the driver unit 15, the sound signal AC4 may strictly be an antiphase signal of the sound signal AC3, or the sound signal AC4 may be an approximate signal of the antiphase signal of the sound signal AC3. For example, the approximate signal of the antiphase signal of the sound signal AC3 may be (1) a signal obtained by shifting a phase of the antiphase signal of the sound signal AC3, (2) a signal obtained by changing (amplifying or attenuating) an amplitude of the antiphase signal of the sound signal AC3, or (3) a signal obtained by shifting the phase of the antiphase signal of the sound signal AC3 and further changing the amplitude. A phase difference between the antiphase signal of the sound signal AC3 and the approximate signal thereof is desirably smaller than or equal to 53% of one period of the antiphase signal of the sound signal AC3. Examples of 53% include 1%, 3%, 5%, 10%, and 20%. In addition, a difference between the amplitude of the antiphase signal of the sound signal AC3 and the amplitude of the approximate signal thereof is desirably smaller than or equal to 64% of the amplitude of the antiphase signal of the sound signal AC3. Examples of 54% include 1%, 3%, 5%, 10%, and 20%. Note that examples of the type of the driver unit 15 include a dynamic type, a balanced armature type, a hybrid type of the dynamic type and the balanced armature type, and a capacitor type. In addition, the shapes of the driver unit 15 and the diaphragm 153 are not limited. In the present embodiment, for simplification of description, an example in which the outer shape of the driver unit 15 is a substantially cylindrical shape including both end surfaces and the diaphragm 153 is a substantially disk shape is described, but this does not limit the present invention. For example, the outer shape of the driver unit 15 may be a rectangular parallelepiped shape or the like, and the diaphragm 153 may be a dome shape or the like.

As described above, the driver unit 15 is larger in size than the driver unit 11. For example, assuming that the diameter of the driver unit 11 (the diameter in a direction orthogonal to the D1 direction and/or the D2 direction) is set to S11 and the diameter of the driver unit 15 (the diameter in a direction orthogonal to the D1 direction and/or the D2 direction) is set to S21, S21>S11 is satisfied. For example, S21 is greater than or equal to twice S11, S11 is 12 mm, and S21 is 35 mm. In addition, for example, assuming that the diameter of the diaphragm 113 (the diameter in a direction orthogonal to the D1 direction and/or the D2 direction) is set to S12 and the diameter of the diaphragm 153 (the diameter in a direction orthogonal to the D1 direction and/or the D2 direction) is set to S22, S22>S12 is satisfied. For example, S22 is greater than or equal to twice S12, S12 is 10 mm, and S22 is 30 mm. That is, the diameter of the diaphragm 153 (second diaphragm) is larger than the diameter of the diaphragm 113 (first diaphragm).

### <Reflector 13 and Support Portion 14>

The reflector 13 is a concave structure having a rotational paraboloid or a surface approximate to the rotational paraboloid inside. That is, at least a part of an inner wall surface 131 of the reflector 13 is a rotational paraboloid or a surface approximate to the rotational paraboloid. This rotational paraboloid has, for example, a shape formed by rotating a parabola about the axis A1 (specific axis). The entire inner wall surface 131 may be a rotational paraboloid or a surface approximate to the rotational paraboloid, or only a part of the inner wall surface 131 (for example, only the inner wall surface 131 on a bottom portion 131a side or only the inner wall surface 131 on a distal end portion 131c side of the reflector 13) may be a rotational paraboloid or a surface approximate to the rotational paraboloid.

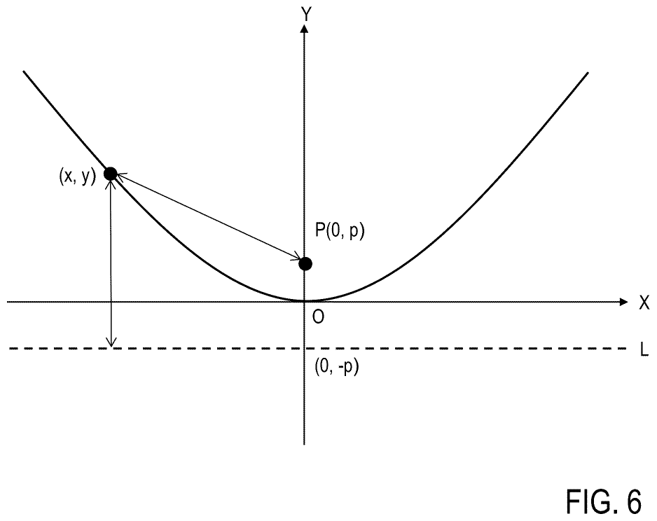

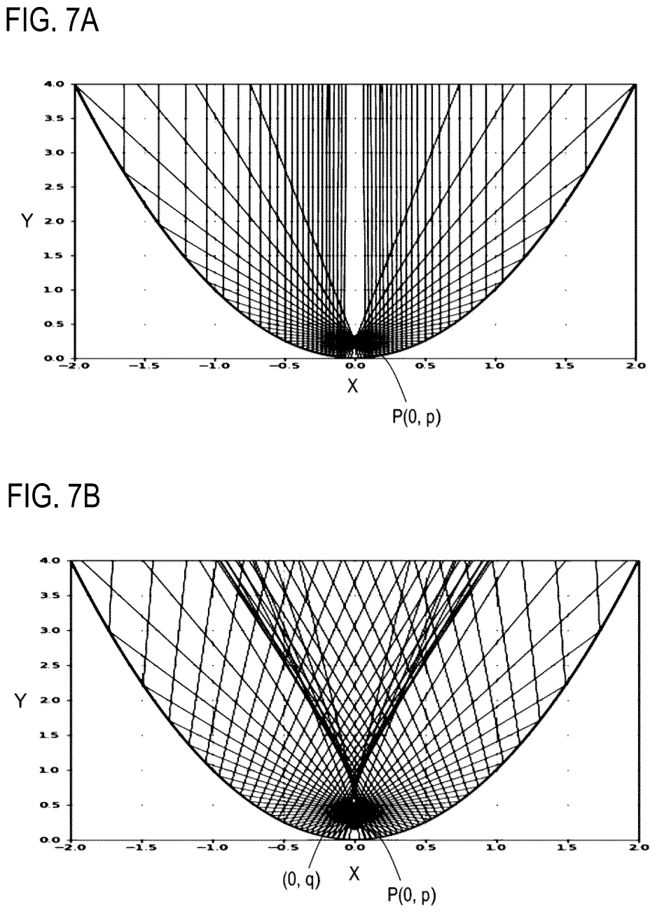

The driver unit 11 is disposed inside the reflector 13. The driver unit 11 is fixed to the inner wall surface 131 of the reflector 13 via the support portion 14. In the present embodiment, the one surface 111 of the driver unit 11 disposed inside the reflector 13 is directed to an open end 130 side (D1 direction side) of the reflector 13, and the other side surface 112 is directed to the bottom portion 131a side (D2 direction side) of the reflector 13. The driver unit 11 (first driver unit) emits the sound signal AC1 (first sound signal) to the D1 direction side (one side) of the driver unit 11, and emits the sound signal AC2 (second sound signal) to the D2 direction side (the other side) of the driver unit 11. The sound signal AC1 (reproduced sound signal) emitted from the driver unit 11 is emitted outward from the open end 130 on the D1 direction side of the reflector 13. Here, a part of the sound signal AC1 is emitted from the driver unit 11 directly to the D1 direction side of the reflector 13. In addition, at least another part of the sound signal AC1 is reflected by the inner wall surface 131 of the reflector 13 and then emitted from the open end 130 to the D1 direction side. In addition, at least a part of the sound signal AC2 is reflected by the inner wall surface 131 of the reflector 13 and then emitted from the open end 130 to the D1 direction side. A user located on the D1 direction side can listen to the sound signal AC1 emitted from the open end 130 of the reflector 13. At this time, the reflector 13 suppresses sound leakage of the sound signal AC1 to a back surface 132 side of the reflector 13. In addition, the sound signal AC2 is an antiphase signal of the sound signal AC1 or an approximate signal of the antiphase signal. Therefore, at a specific position (for example, a position behind the user) on the D1 direction side other than the position where the user is present, a part of the sound signal AC1 cancels out a part of the sound signal AC2, and the sound leakage of the sound signal AC1 is suppressed. Note that the driver unit 11 is desirably disposed on the axis A1, and, for example, the diaphragm 113 is desirably disposed on the axis A1. More preferably, the center or vicinity thereof of the diaphragm 113 is desirably disposed on the axis A1. In other words, it is desirable that the diaphragm 113 is disposed at the center or near the center of the rotational paraboloid described above. Thus, the sound pressure of the sound signal AC1 emitted from the open end 130 is axially symmetric or substantially axially symmetric relative to the axis A1. In addition, more preferably, the driver unit 11 is desirably disposed at the focal point or near the focal point of the rotational paraboloid. In this case, the directivity of the sound signal AC1 emitted from the open end 130 is enhanced. Details will be described below. As illustrated in FIG. 6, on X-Y coordinates, a point on a parabola forming the rotational paraboloid is defined as (x, y), a focal point of the rotational paraboloid is defined as P(0, p), and a directrix parallel to an X axis passing through a point (0, −p) is defined as L:y=−p. Here, p≠0. In this case, a set of points (x, y) having the same distance from the focal point P(0, p) and the directrix L:y=−p satisfies x²=4py. As illustrated in FIG. 7A, in a case where the driver unit 11 is disposed at the focal point P(0, p) or in the vicinity of the focal point P(0, p) of the rotational paraboloid, the center in the traveling direction of the sound signal AC1 emitted from the open end 130 is parallel to the Y axis (axis A1). Therefore, when the driver unit 11 is disposed at the focal point P(0, p) or in the vicinity of the focal point P(0, p) of the rotational paraboloid, the directivity of the sound signal AC1 emitted from the open end 130 is enhanced. On the other hand, as illustrated in FIG. 7B, in a case where the driver unit 11 is disposed at the focal point P(0, p) or a position (0, q) deviated from the vicinity of the focal point P(0, p) of the rotational paraboloid (p≠q), the center in the traveling direction of the sound signal AC1 emitted from the open end 130 spreads outward with respect to the Y axis. In this case, as compared with the case where the driver unit 11 is disposed at the focal point P(0, p) or in the vicinity of the focal point P(0, p) of the rotational paraboloid, the directivity of the sound signal AC1 emitted from the reflector 13 is lower.

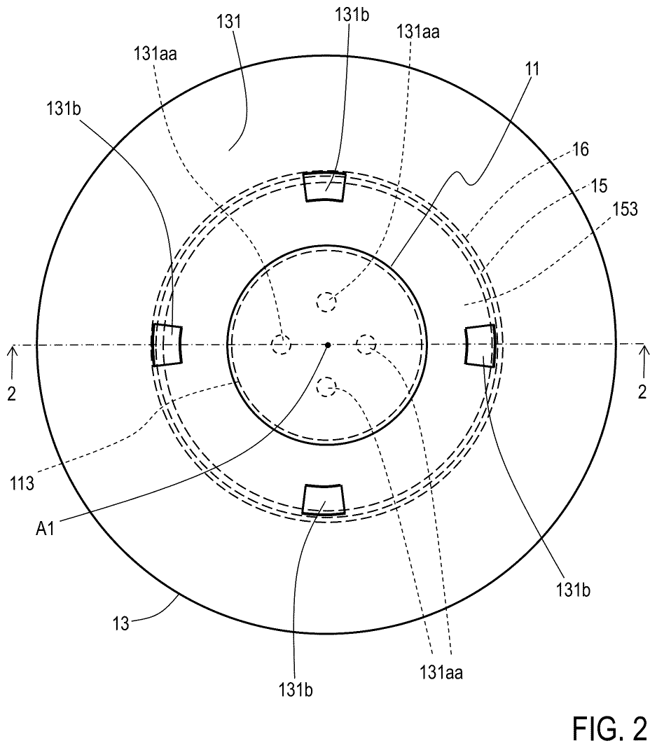

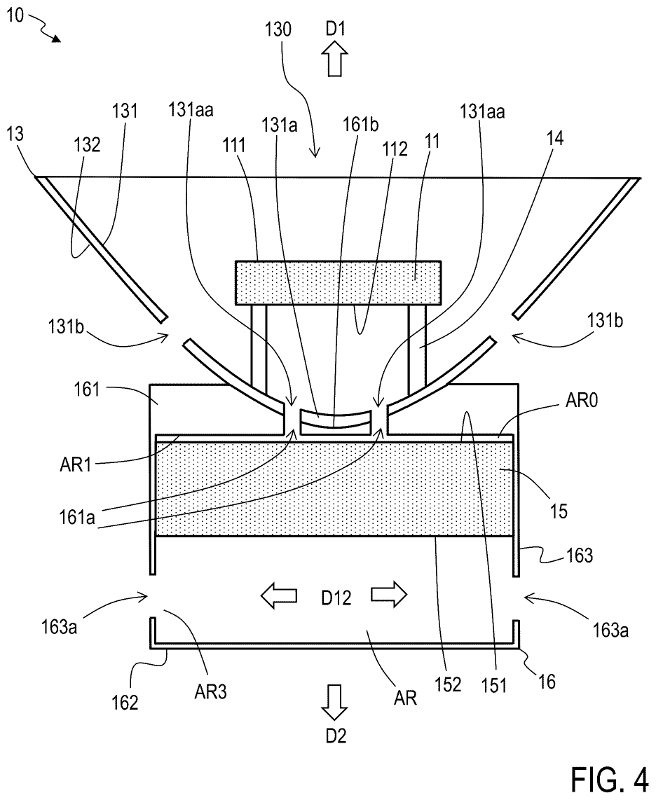

The sound signals AC1 and AC2 have shorter wavelengths and higher straightness as the frequency is higher. Therefore, the directivity of the high-frequency components of the sound signals AC1 and AC2 emitted from the open end 130 of the reflector 13 is high, and the high-frequency components hardly leak to the back surface 132 side of the reflector 13. Here, a part of the sound signal AC2 is reflected by the inner wall surface 131 of the reflector 13 and then emitted from the open end 130 to the D1 direction side. The sound signal AC2 is an antiphase signal of the sound signal AC1 or an approximate signal of the antiphase signal. However, these high-frequency components have a short wavelength and are difficult to cancel out each other. Therefore, on the D1 direction side, the sound pressure of the high-frequency components of the sound signal AC1 can be sufficiently secured. On the other hand, the directivity of medium- and low-frequency components of the sound signals AC1 and AC2 emitted from the open end 130 is low, and the sound signals AC1 and AC2 easily leak to the back surface 132 side. However, the sound signal AC2 is an antiphase signal of the sound signal AC1 or an approximate signal of the antiphase signal, and these low-frequency components have a long wavelength and are likely to cancel out each other. Therefore, even when the low-frequency components of the sound signals AC1 and AC2 leak to the back surface 132 side, the low-frequency components cancel out each other, and thus the sound leakage can be suppressed. In order for the sound signal AC2 to cancel out the sound signal AC1 at the position where sound leakage is to be suppressed, it is ideal that a difference between the propagation distance from the one-side surface 111 of the driver unit 11 to the position where sound leakage is to be suppressed and the propagation distance from the other side surface 112 of the driver unit 11 to the position where sound leakage is to be suppressed is an integral multiple (including a case of being equal) of the wavelengths of the sound signals AC1 and AC2. In order to optimize this condition, the reflector 13 of the present embodiment is provided with one or a plurality of sound holes 131b (reflector sound holes). Thus, the sound leakage of the medium- and low-frequency components of the sound signals AC1 and AC2 can be suppressed. In addition, the sound hole 131b also has a function of weakening the directivity of the high-frequency components of the sound signals AC1 and AC2. When the sound pressure of the high-frequency component is too high, it may be felt unpleasant, but, by providing the sound hole 131b, the sound pressure of the high-frequency components of the sound signals AC1 and AC2 emitted to the D1 direction side can be weakened. Note that FIG. 2 and the like illustrate an example in which four rectangular sound holes 131b are disposed in the reflector 13 in axial symmetry or substantially axial symmetry relative to the axis A1. However, this does not limit the present invention, and a sound hole 131b having a circular shape, a triangular shape, or the like may be provided, a plurality of sound holes 131b having different shapes and sizes may be provided, or the sound holes 131b may be disposed eccentrically at any position. For example, the sound holes 131b may be disposed eccentrically in a direction in which sound leakage of the sound signal AC1 becomes a problem. In addition, as illustrated in FIGS. 1, 4, and the like, the sound holes 131b are desirably disposed on the D2 direction side (the other side) of the driver unit 11 (first driver unit) or in the vicinity of the D2 direction side (the other side) of the driver unit 11 (first driver unit). Thus, the sound signal AC1 emitted from the D1 direction side of the driver unit 11 is less likely to be emitted from the sound holes 131b, and the sound signal AC2 emitted from the D2 direction side of the driver unit 11 is likely to be emitted from the sound holes 131b. As a result, the difference in propagation distance between the sound signal AC1 and the sound signal AC2, which is described above, can be easily adjusted depending on the size, number, arrangement, and the like of the sound hole 131b. Note that the sound holes 131b are sound holes penetrating the reflector 13, but this does not limit the present invention. As long as the sound signal inside the reflector 13 can be led out to the outside, the sound holes 131b may not be through holes. Here, for simplification of description, a case where the shape of the edge of the open end of the sound hole 131b is a quadrangle (the case where the open end is rectangle) is described, but this does not limit the present invention. For example, the shape of the edge of the open end of the sound hole 131b may be another shape such as a circle, an ellipse, and a triangle. In addition, the open end of the sound hole 131b may have a mesh shape.

With the configuration described above, when the sound signal AC1 (first sound signal) is emitted from the D1 direction side (one side) of the driver unit 11 (first driver unit) and the sound signal AC2 (second sound signal) is emitted from the D2 direction side (the other side) of the driver unit 11 (first driver unit), an attenuation rate η₁₁ of the sound signal AC1 (first sound signal) at a position P2 (second point) with reference to a position P1 (first point) can be set to be smaller than or equal to a predetermined value ηₜₕ, or an attenuation amount η₁₂ of the sound signal AC1 (first sound signal) at the position P2 (second point) with reference to the position P1 (first point) can be set to be larger than or equal to a predetermined value ωₜₕ. Here, the position P1 (first point) is a predetermined point where the sound signal AC1 (first sound signal) reaches. On the other hand, the position P2 (second point) is a predetermined point whose distance from the sound signal output apparatus 10 is longer than the position P1 (first point). The predetermined value ηₜₕ is a value smaller (value lower) than an attenuation rate η₂₁ of any or specific sound signal (sound) due to air propagation at the position P2 (second point) with reference to the position P1 (first point). In addition, the predetermined value ωₜₕ is a value larger than an attenuation amount η₂₂ of any or specific sound signal (sound) due to air propagation at the position P2 (second point) with reference to the position P1 (first point). That is, the sound signal output apparatus 10 is designed such that the attenuation rate ηₜₕ is smaller than or equal to the predetermined value ηₜₕ smaller than the attenuation rate η₂₁ or such that the attenuation amount η₁₂ is larger than or equal to the predetermined value ωₜₕ larger than the attenuation amount η₂₂. Note that the sound signal AC1 is propagated in air from the position P1 to the position P2 and is attenuated due to air propagation and the sound signal AC2. The attenuation rate ηₜₕ is a ratio (AMP₂ (AC1)/AMP₁ (AC1)) of a magnitude AMP₂(AC1) of the sound signal AC1 at the position P2 attenuated due to air propagation and the sound signal AC2 to a magnitude AMP₁(AC1) of the sound signal AC1 at the position P1. In addition, the attenuation amount η₁₂ is a difference (|AMP₁(AC1)−AMP₂(AC1)|) between the magnitude AMP₁(AC1) and the magnitude AMP₂(AC1). Meanwhile, in a case where the sound signal AC2 is not assumed, any or specific sound signal ACₐᵣ propagating in air from the position P1 to the position P2 attenuates not due to the sound signal AC2 but due to the air propagation. The attenuation rate η₂₁ is a ratio (AMP₂ (ACₐᵣ)/AMP₁ (ACₐᵣ)|) of a magnitude AMP₂ (ACₐᵣ) of the sound signal ACₐᵣ at the position P2 attenuated due to air propagation (attenuated not due to the sound signal AC2) to a magnitude AMP₁(ACₐᵣ) of the sound signal ACₐᵣ at the position P1. In addition, the attenuation amount η₂₂ is a difference (|AMP₁(ACₐᵣ)−AMP₂ (ACₐᵣ)|) between the magnitude AMP₁(ACₐᵣ) and the magnitude AMP₂(ACₐᵣ). Note that an example of the magnitude of the sound signal is the sound pressure of the sound signal, energy of the sound signal, or the like. In addition, the “sound leakage component” means, for example, a component that is highly likely to arrive at an area (for example, a human other than the user present in the D1 direction) other than the user present in the D1 direction in the sound signal AC1 emitted from sound holes 161a. For example, the “sound leakage component” may be a component propagating to an area other than the specific area on the D1 direction side in the sound signal AC1, or may be a component propagating to an area other than the area on the D1 direction side.

In addition, as illustrated in FIGS. 1, 4, and the like, sound holes 131aa (reflector sound holes) connected to the internal space of the housing 16 are provided in the bottom portion 131a side (D2 direction side) of the reflector 13. The sound holes 131aa are sound holes penetrating the reflector 13, but this does not limit the present invention. As long as the sound signal in the internal space of the housing 16 can be led out to the inside of the reflector 13, the sound holes 131aa may not be through holes. Details of the sound holes 131aa will be described below.

The material of the reflector 13 is not limited, but at least the inner wall surface 131 is desirably made of a material that reflects the sound signal. For example, the reflector 13 may be formed of a rigid body such as synthetic resin or metal, or may be formed of an elastic body such as rubber.

### <Housing 16>

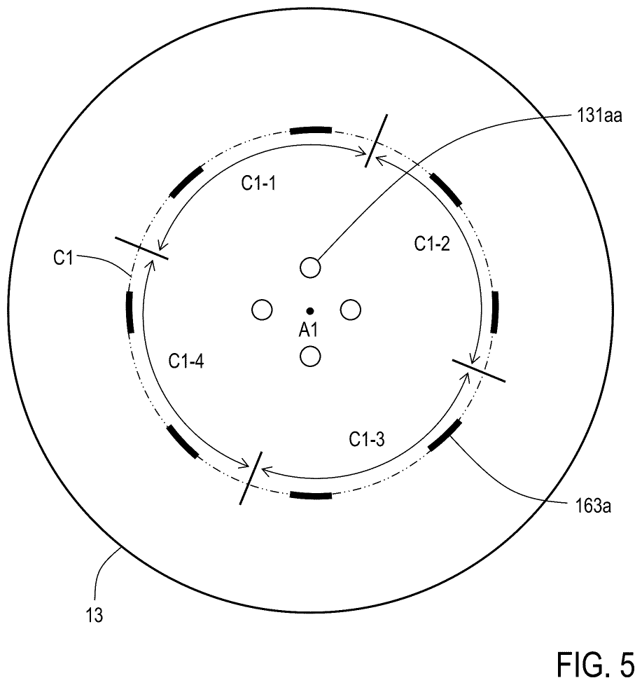

The housing 16 (second housing) is a hollow member having a wall portion outside, and is disposed outside the reflector 13. The housing 16 of the present embodiment is disposed on the D2 direction side of the reflector 13. The driver unit 15 (second driver unit) is accommodated in the housing 16. The driver unit 15 in this example is fixed at a position away from a wall portion 161 on the D1 direction side of the housing 16 by a certain distance. Thus, a hollow area AR0 is provided between an area AR1 inside the wall portion 161 of the housing 16 of this example and the surface 151 on the D1 direction side of the driver unit 15. The wall portion of the housing 16 includes one or a plurality of sound holes 161a (third sound holes) for leading out the sound signal AC3 (third sound signal) emitted from the driver unit 15 to the inside of the reflector 13 via the sound holes 131aa and one or a plurality of sound holes 163a (fourth sound holes) for leading out the sound signal AC4 (fourth sound signal) emitted from the driver unit 15 to the outside of the reflector 13 outside the housing 16. In the example of the present embodiment, a recess 161b is provided outside the wall portion 161 on one side (D1 direction side) of the housing 16, and the outside of the bottom portion 131a of the reflector 13 is fixed to the recess 161b. The sound holes 161a (third sound holes) are provided in the recess 161b and are connected to the sound holes 131aa (reflector sound holes) of the reflector 13 (FIGS. 1 and 4). Thus, the sound signal AC3 emitted from the driver unit 15 to the area AR0 is led out to the inside of the reflector 13 through the sound holes 161a and the sound holes 131aa. The sound signal AC3 led out to the inside of the reflector 13 is emitted from the open end 130 of the reflector 13 to the D1 direction side. Note that the sound holes 131aa (reflector sound holes) connected to the sound holes 161a (third sound holes) or the center of the plurality of sound holes 131aa (reflector sound holes) connected to one or a plurality of sound holes 161a (third sound holes) is desirably disposed on the axis A1 (axis) or near the axis A1 (axis) (for example, FIG. 5). Thus, this is because the sound pressure of the sound signal AC3 emitted from the open end 130 of the reflector 13 is axially symmetric or substantially axially symmetric relative to the axis A1. In addition, the sound holes 163a face the external space on the back surface 132 side of the reflector 13, and the sound signal AC4 emitted to a hollow area AR (internal space) of the housing 16 on the D2 direction side of the driver unit 15 is led out to the outside of the reflector 13 through the sound holes 163a. As described above, the sound signal AC4 is an antiphase signal of the sound signal AC3 or an approximate signal of the antiphase signal. In addition, the sound signal AC3 is an in-phase signal of the sound signal AC1 or an approximate signal of the in-phase signal, and the sound signal AC4 is an in-phase signal of the sound signal AC2 or an approximate signal of the in-phase signal. Thus, at least a part of the sound signal AC4 emitted from the sound holes 163a cancels out at least a part of sound leakage components of the sound signals AC1 and AC3 emitted from the open end 130 of the reflector 13. Thus, the sound leakage, in particular, the sound leakage of the low-frequency side (sound signal AC3) can be suppressed. Note that the sound holes 161a and the sound holes 163a are, for example, sound holes penetrating the wall portion of the housing 16, but this does not limit the present invention. As long as the sound signal AC3 can be led out to the inside of the reflector 13 and the sound signal AC4 can be led out to the outside of the reflector 13, the sound holes 161a and the sound holes 163a may not be through holes. Although the shape of the housing 16 is not limited, for example, the shape of the housing 16 is desirably rotationally symmetric (axially symmetric) or substantially rotationally symmetric relative to the axis A1. Thus, it is easy to provide the sound holes 163a so as to reduce variation in sound pressure in each direction of the sound signal AC4 emitted from the housing 16. As a result, the sound leakage can be easily reduced uniformly in each direction. For example, the housing 16 includes the wall portion 161 disposed on one side (D1 direction side) of the driver unit 15, a wall portion 162 disposed on the other side (D2 direction side) of the driver unit 15, and a wall portion 163 surrounding a space sandwiched between the wall portion 161 and the wall portion 162 about the axis A1 passing through the wall portion 161 and the wall portion 162 (FIGS. 1 and 4). Here, for simplification of description, an example is described in which the housing 16 has a substantially cylindrical shape including both end surfaces. However, these are examples and do not limit the present invention. For example, the housing 16 may have a substantially dome shape including a wall portion at an end portion, may have a hollow substantially cubic shape, or may have another three-dimensional shape. In addition, the material of the housing 16 is not limited. The housing 16 may be formed of a rigid body such as synthetic resin or metal or may be formed of an elastic body such as rubber.

A user located in a specific area on the D1 direction side can listen to the sound signals AC1 and AC3 emitted from the open end 130 of the reflector 13. As described above, the sound signal AC2 that is an antiphase signal of the sound signal AC1 or an approximate signal of the antiphase signal is emitted from the sound holes 131b. In addition, the sound signal AC4 that is an antiphase signal of the sound signal AC3 or an approximate signal of the antiphase signal is emitted from the sound holes 163a. Here, a part of the emitted sound signals AC2 and AC4 cancels out a part of the sound signals AC1 and AC3 (sound leakage components) emitted from the open end 130 of the reflector 13. For example, a part of the sound signal AC2 mainly cancels out a part of the sound signal AC1, and a part of the sound signal AC4 mainly cancels out a part of the sound signal AC3. That is, the sound signal AC1 (first sound signal) is emitted from the D1 direction side (one side) of the driver unit 11 (first driver unit), the sound signal AC2 (second sound signal) is emitted from the D2 direction side (the other side) of the driver unit 11 (first driver unit), the sound signal AC3 (third sound signal) is emitted from the D1 direction side (one side) of the driver unit 15 (second driver unit), and the fourth sound signal is emitted from the D2 direction side (the other side) of the driver unit 15 (second driver unit), and therefore, attenuation rates η₁₁₂ of the sound signal AC1 (first sound signal) and the sound signal AC3 (third sound signal) at the position P2 (second point) with reference to the position P1 (first point) can be set to be smaller than or equal to a predetermined value ηₜₕ, or attenuation amounts η₁₁₂₂ of the sound signal AC1 (first sound signal) and the sound signal AC3 (third sound signal) at the position P2 (second point) with reference to the position P1 (first point) can be set to be larger than or equal to a predetermined value ωₜₕ. Here, the position P1 (first point) is a predetermined point where the emitted sound signal AC1 (first sound signal) and sound signal AC3 (third sound signal) reach. On the other hand, the position P2 (second point) is a predetermined point whose distance from the sound signal output apparatus 10 is longer than the position P1 (first point). The predetermined value ηₜₕ is a value smaller (value lower) than an attenuation rate η₂₁ of any or specific sound signal (sound) due to air propagation at the position P2 (second point) with reference to the position P1 (first point). In addition, the predetermined value ωₜₕ is a value larger than an attenuation amount η₂₂ of any or specific sound signal (sound) due to air propagation at the position P2 (second point) with reference to the position P1 (first point). That is, the sound signal output apparatus 10 of the present embodiment is designed such that the attenuation rate η₁₁₂ is less than or equal to the predetermined value ηₜₕ smaller than the attenuation rate η₂₁, or the attenuation amount η₁₂₂ is larger than or equal to the predetermined value ωₜₕ larger than the attenuation amount η₂₂. Note that the sound signal AC1 and the sound signal AC3 are propagated in air from the position P1 to the position P2 and are attenuated due to the air propagation, the sound signal AC2, and the sound signal AC4. The attenuation rate η₁₁₂ is a ratio (AMP₂ (AC1)/AMP₁(AC1)) of the magnitude AMP₂(AC1) of the sound signal AC1 at the position P2 attenuated due to the air propagation, the sound signal AC2, and the sound signal AC4 to the magnitude AMP₁(AC1) of the sound signal AC1 at the position P1, or a ratio (AMP₂ (AC3)/AMP₁ (AC13)) of the magnitude AMP₂(AC3) of the sound signal AC3 at the position P2 attenuated due to the air propagation, the sound signal AC2, and the sound signal AC4 to the magnitude AMP₁(AC3) of the sound signal AC3 at the position P1. Alternatively, the attenuation rate η₁₁₂ may be a statistical value (an average value, an addition value, a multiplication value, or the like) of the ratio (AMP₂ (AC1)/AMP₁(AC1)) and the ratio (AMP₂ (AC3)/AMP₁(AC13)). In addition, the attenuation amount η₁₂₂ is a difference (AMP₁(AC1)−AMP₂(AC1)|) between the magnitude AMP₁(AC1) and the magnitude AMP₂(AC1), or a difference (|AMP₁(AC3)−AMP₂(AC3)|) between the magnitude AMP₁(AC3) and the magnitude AMP₂(AC3). Alternatively, the attenuation amount η₁₂₂ may be a statistical value (an average value, an addition value, a multiplication value, or the like) of the difference (|AMP₁(AC1)−AMP₂(AC1)|) and the difference (|AMP₁(AC3)−AMP₂(AC3)|). On the other hand, in a case where the sound signal AC2 and the sound signal AC4 are not assumed, any or specific sound signal ACₐᵣ propagating in air from the position P1 to the position P2 attenuates not due to the sound signal AC2 and the sound signal AC4 but due to the air propagation. The attenuation rate η₂₁ is a ratio (AMP₂ (ACₐᵣ)/AMP₁ (ACₐᵣ)|) of a magnitude AMP₂ (ACₐᵣ) of the sound signal ACₐᵣ at the position P2 attenuated due to air propagation (attenuated not due to the sound signal AC2) to a magnitude AMP₁(ACₐᵣ) of the sound signal ACₐᵣ at the position P1. In addition, the attenuation amount η₂₂ is a difference (|AMP₁ (ACₐᵣ)−AMP₂ (ACₐᵣ)|) between the magnitude AMP₁ (ACₐᵣ) and the magnitude AMP₂ (ACₐᵣ).

With the configuration described above, it is possible to suppress the sound leakage. In particular, the size of the driver unit 11 (first driver unit) is smaller than the size of the driver unit 15 (second driver unit). In addition, the driver unit 11 is disposed inside the reflector 13, and the sound signals AC1 and AC2 emitted from the driver unit 11 are emitted from the open end 130 of the reflector 13 and the sound holes 131b. On the other hand, the driver unit 15 is accommodated inside the housing 16 located outside the reflector 13, and the sound signal AC3 emitted from the driver unit 15 is introduced into the inside of the reflector 13 and then emitted further from the open end 130 of the reflector 13. On the other hand, the sound signal AC4 emitted from the driver unit 15 is emitted from the sound holes 163a of the housing 16 to the outside of the reflector 13. Therefore, a difference between the propagation distance until the sound signal AC1 emitted from the D1 direction side of the diaphragm 113 of the driver unit 11 reaches the position P2 (second point) and the propagation distance until the sound signal AC2 (second sound signal) emitted from the D2 direction side (the other side) of the diaphragm 113 reaches the position P2 (second point) is smaller than a difference between the propagation distance until the sound signal AC3 emitted from the D1 direction side (one side) of the diaphragm 153 of the driver unit 15 reaches the position P2 (second point) and the propagation distance until the sound signal AC4 emitted from the D2 direction side (the other side) of the diaphragm 153 reaches the position P2 (second point). Here, the phase difference between an antiphase wave (the sound signal AC2 or the sound signal AC4) at the position P2 and a reproduced sound (the sound signal AC1 or the sound signal AC3) is larger as the difference in propagation distance is smaller, and the sound leakage prevention effect is improved. Therefore, in terms of the size and arrangement, the sound leakage prevention effect is higher on the driver unit 11 side than on the driver unit 15 side. On the other hand, since it is more easily affected by the difference in propagation distance as the frequency is higher, the sound leakage prevention effect is more likely to deteriorate as the frequency is higher. Here, the driver unit 11 mainly handles a high-frequency sound signal among the reproduced sound signals, and the driver unit 15 mainly handles a low-frequency sound signal among the reproduced sound signals. Therefore, in terms of the frequency, the sound leakage prevention effect is higher on the driver unit 15 side than on the driver unit 11 side. With these characteristics of the sound leakage prevention effect, a sufficient sound leakage prevention effect can be obtained in a wide frequency band. In addition, since the diameter of the diaphragm 153 (second diaphragm) of the driver unit 15 is larger than the diameter of the diaphragm (first diaphragm) of the driver unit 11, the sound pressure of the low sound can be made larger on the driver unit 15 side than the driver unit 11. Thus, it is possible to sufficiently obtain a low-frequency sound pressure while suppressing the sound leakage.

<Arrangement Configuration of Sound Holes 161a and 163a>

An arrangement configuration of the sound holes 161a and 163a will be exemplified.

The sound holes 161a (third sound holes) exemplified here are provided in the area AR1 (first area) of the wall portion 161 disposed on one side (D1 direction side that is a side to which the sound signal AC3 is emitted) of the driver unit 15 (FIGS. 1 and 4). That is, the sound holes 161a are opened in the D1 direction (first direction) along the axis A1, and are connected to the sound holes 131aa of the reflector 13. In addition, the sound holes 163a (fourth sound holes) exemplified here are provided in an area AR3 of the wall portion 163 that is in contact with an area AR between the area AR1 (first area) of the wall portion 161 of the housing 16 and an area AR2 (second area) of the wall portion 162 disposed on the D2 direction side (the other side that is a side to which the sound signal AC4 is emitted) of the driver unit 15. That is, assuming that a direction between the D1 direction (first direction) and the opposite direction of the D1 direction is a D12 direction (second direction) using the center of the housing 16 as a reference (FIG. 4), the sound holes 161a (third sound holes) are provided on the D1 direction side (first direction side) of the housing 16, and the sound holes 163a (fourth sound holes) are provided on the D12 direction side (second direction side) of the housing 16. For example, in a case where the housing 16 includes the wall portion 161 disposed on one side (D1 direction side) of the driver unit 15, the wall portion 162 disposed on the other side (D2 direction side) of the driver unit 15, and the wall portion 163 (side surface) surrounding the space sandwiched between the wall portion 161 and the wall portion 162 about the axis A1 along the emission direction (D1 direction) of the sound signal AC3 passing through the wall portion 161 and the wall portion 162 (FIG. 4), the sound holes 161a (third sound holes) are provided in the wall portion 161, and the sound holes 163a (fourth sound holes) are provided in the wall portion 163 (side surface). In addition, in this example, it is desirable that a sound hole is not provide in the wall portion 162 side of the housing 16. This is because when a sound hole is provided in the wall portion 162 side of the housing 16, the sound pressure level of the sound signal AC4 emitted from the housing 16 exceeds a level necessary for cancelling out the sound leakage component of the sound signal AC3, and the excess is perceived as sound leakage.

As illustrated in FIG. 1 and the like, the sound holes 161a exemplified here are disposed on or near the axis A1 along the emission direction (D1 direction) of the sound signal AC3. The axis A1 of this example passes through the center or the vicinity of the center of the area AR1 (first area) of the wall portion 161 disposed on one side (D1 direction side) of the driver unit 15 of the housing 16. For example, the axis A1 is an axis extending in the D1 direction through the center area of the housing 16. That is, the sound holes 161a of this example are provided at the center position of the area AR1 of the wall portion 161 of the housing 16. In this example, for simplification of description, an example is described in which the shape of the edge of the open end of the sound hole 161a is a circle (the open end is a circle). However, this does not limit the present invention. For example, the shape of the edge of the open end of the sound hole 161a may be another shape such as an ellipse, a quadrangle, and a triangle. In addition, the open end of the sound hole 161a may have a mesh shape. In other words, the open end of the sound hole 161a may be formed by a plurality of holes. In addition, in this example, for simplification of description, an example is described in which four sound holes 161a are provided in the area AR1 (first area) of the wall portion 161 of the housing 16. However, this does not limit the present invention. For example, one or more sound holes 161a may be provided in the area AR1 (first area) of the wall portion 161 of the housing 16, or other numbers of sound holes 161a may be provided.

The sound holes 163a (fourth sound holes) are desirably disposed in consideration of, for example, the viewpoints described below.
(1) Viewpoint of position: The sound holes 163a are disposed such that the propagation paths of the sound signal AC4 emitted from the sound holes 163a overlap the propagation path of the sound leakage component of the sound signal AC3 to be canceled out.
(2) Viewpoint of area: The propagation areas of the sound signal AC4 emitted from the sound holes 163a and the frequency characteristics of the housing 16 are different depending on the opening areas of the sound holes 163a. In addition, the frequency characteristics of the housing 16 affect the frequency characteristics of the sound signal AC4 emitted from the sound holes 163a, that is, the amplitude at each frequency. In consideration of such propagation areas and frequency characteristics of the sound signal AC4 emitted from the sound holes 163a, the opening areas of the sound holes 163a are determined such that the sound leakage component is canceled out by the sound signal AC4 emitted from the sound holes 163a in an area where the sound leakage component is to be canceled out.

From the above viewpoints, for example, the sound holes 163a (fourth sound holes) are desirably formed as described below.

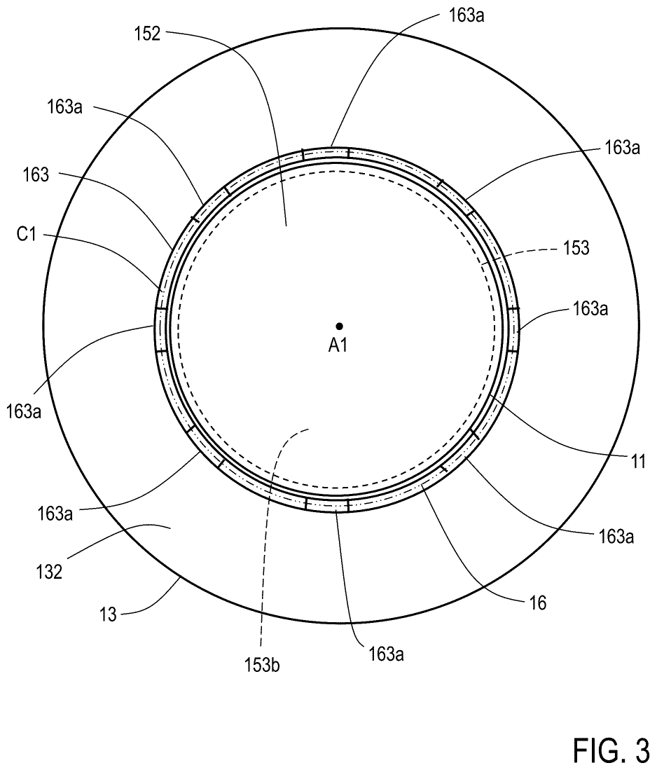

For example, as illustrated in FIGS. 3 and 5, desirably, the plurality of sound holes 163a (fourth sound holes) is provided along a circumference (circle) C1 about the axis A1 along the emission direction of the sound signal AC3 (first sound signal). In a case where the plurality of sound holes 163a is provided along the circumference C1, the sound signal AC4 is emitted radially (radially about the axis A1) from the sound holes 163a to the outside. Here, the sound leakage component of the sound signal AC3 is also emitted radially (radially about the axis A1) from the sound hole 161a to the outside. Therefore, when the plurality of sound holes 163a is provided along the circumference C1, the sound leakage component of the sound signal AC3 can be appropriately canceled out by the sound signal AC4. Here, for simplification of description, an example is described in which the plurality of sound holes 163a is provided on the circumference C1. However, the plurality of sound holes 163a is only required to be provided along the circumference C1, and not all the sound holes 163a need to be strictly disposed on the circumference C1.

In addition, preferably, in a case where the circumference C1 is equally divided into a plurality of unit arc areas, the sum of the opening areas of sound holes 163a (fourth sound holes) provided along a first arc area that is one of the unit arc areas is the same as or substantially the same as the sum of the opening areas of sound holes 163a (fourth sound holes) provided along a second arc area that is one of the unit arc areas excluding the first arc area. For example, as illustrated in FIG. 5, in a case where the circumference C1 is equally divided into four unit arc areas C1-1, . . . , and C1-4, the sum of the opening areas of the sound holes 163a (fourth sound holes) provided along the first arc area (for example, unit arc area C1-1) that is one of the unit arc areas C1-1, . . . , and C1-4 is the same as or substantially the same as the sum of the opening areas of the sound holes 163a (fourth sound holes) provided along the second arc area (for example, unit arc area C1-2) that is one of the unit arc areas excluding the first arc area. Note that, for simplification of description, an example has been described in which the circumference C1 is equally divided into four unit arc areas C1-1, . . . , and C1-4, but this does not limit the present invention. In addition, “α1 is substantially the same as α2” means that the difference between α1 and α2 is β% or less of α1. Examples of β% include 3%, 5%, and 10%. Thus, the sound pressure distribution of the sound signal AC4 emitted from the sound holes 163a provided along the first arc area and the sound pressure distribution of the sound signal AC4 emitted from the sound holes 163a provided along the second arc area are axially symmetric or substantially axially symmetric relative to the axis A1. Preferably, the sums of the opening areas of sound holes 163a (fourth sound holes) provided along the unit arc areas for the respective unit arc areas are all the same or substantially the same. Thus, the sound pressure distribution of the sound signal AC4 emitted from the sound holes 163a is axially symmetric or substantially axially symmetric relative to the axis A1. Thus, the sound leakage component of the sound signal AC3 can be more appropriately canceled out by the sound signal AC4.

More preferably, the plurality of sound holes 163a having the same shape, the same size, and the same interval is desirably provided along the circumference C1. In a case where the plurality of sound holes 163a having the same shape, the same size, and the same interval is provided along the circumference C1, the sound leakage component of the sound signal AC3 can be more appropriately canceled out by the sound signal AC4. However, this does not limit the present invention.

Here, for simplification of description, a case where the shape of the edge of the open end of the sound hole 163a is a quadrangle (a case where the open end is a rectangle) is exemplified, but this does not limit the present invention. For example, the shape of the edge of the open end of the sound hole 163a may be another shape such as a circle, an ellipse, and a triangle. In addition, the open end of the sound hole 163a may have a mesh shape. In other words, the open end of the sound hole 163a may be formed by a plurality of holes. In addition, the number of sound holes 163a is not limited, and a single sound hole 163a may be provided in the area AR3 of the wall portion 163 of the housing 16, or a plurality of sound holes 163a may be provided.

<Cutoff Frequency of Reflector 13 in which Driver Unit 11 is Disposed>

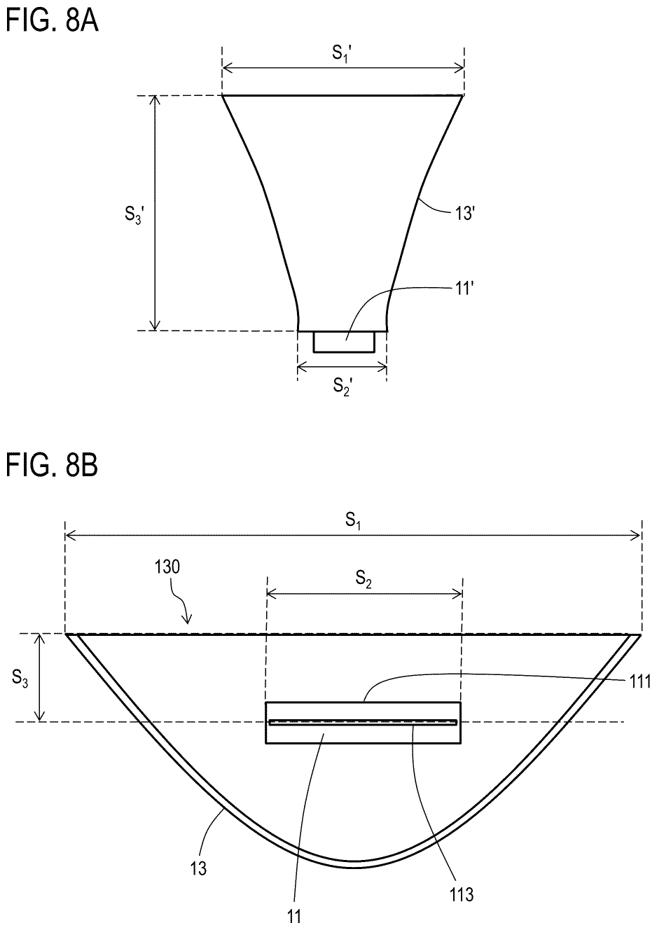

The cutoff frequency (cut-off frequency) of the reflector 13 in which the driver unit 11 is disposed will be considered. FIG. 8A illustrates a horn speaker in which a horn 13′ is attached to a driver unit 11′. Here, the opening area of a mouth portion of the horn 13′ is set to S₁′, the opening area of a throat portion of the horn 13′ is set to S₂′, and the length of the horn 13′ is set to S₃′. The driver unit 11′ is attached to the mouth portion of the horn 13′. A cutoff frequency f_{c} of the horn speaker is represented by Equation (1) below.

$$\begin{matrix}[ Math . 1 ] & \\ {f}_{c} = \frac{m c}{4 π} & ( 1 )\end{matrix}$$

Here, m represents a broadening coefficient, and c represents a sound speed. Note that the sound pressure of the sound signal emitted from the mouth portion of the horn speaker rapidly decreases when the sound pressure exceeds the cutoff frequency f_{c}. That is, the cutoff frequency f_{c} represents the frequency characteristics of the sound signal that can be output from the horn speaker. Here, it is known that the relationship of Equation (2) below holds.

$$\begin{matrix}[ Math . 2 ] & \\ {S}_{2}^{′} = {S}_{1}^{′} {e}^{{mS}_{{3}^{′}}} & ( 2 )\end{matrix}$$

When Equation (2) is modified, Equation (3) is satisfied below.

$$\begin{matrix}[ Math . 3 ] & \\ {mS}_{3}^{′} = {log}_{e} \frac{{S}_{2}^{′}}{{S}_{1}^{′}} & ( 3 )\end{matrix}$$

Moreover, when Equation (3) is modified, the broadening coefficient m can be approximated as in Equation (4) below.

$$\begin{matrix}[ Math . 4 ] & \\ m \approx \frac{2.3}{{S}_{3}^{′}} {log}_{10} \frac{{S}_{2}^{′}}{{S}_{1}^{′}} & ( 4 )\end{matrix}$$

Although the reflector 13 of the present embodiment is different from the horn, it is considered that the cutoff frequency of the reflector 13 in which the driver unit 11 is disposed exhibits close characteristics. FIG. 8B illustrates the reflector 13 in which the driver unit 11 of the present embodiment is disposed. Here, an opening area S₁ of the open end 130 of the reflector 13 is regarded as the opening area S₁′ of the mouth portion of the horn, the area S₂ of the surface 111 of the driver unit 11 is regarded as the opening area S₂′ of the throat portion of the horn, and the length S₃ from the surface 111 of the driver unit 11 to the open end 130 of the reflector 13 is regarded as the length S₃′ of the horn. Then, from Equations (1) and (4), the cutoff frequency f_{c} of the reflector 13 in which the driver unit 11 is disposed can be approximated as in Equation (5) below.

$$\begin{matrix}[ Math . 5 ] & \\ {f}_{c} \approx \frac{2.3 c}{4 π {S}_{3}} {log}_{10} \frac{{S}_{2}}{{S}_{1}} & ( 5 )\end{matrix}$$

That is, the reflector 13 in which the driver unit 11 is disposed can be regarded as a speaker having the cutoff frequency f_{c} represented by Equation (5).

### <Reproduction Apparatus 100 and Signal Separation Apparatus 101>

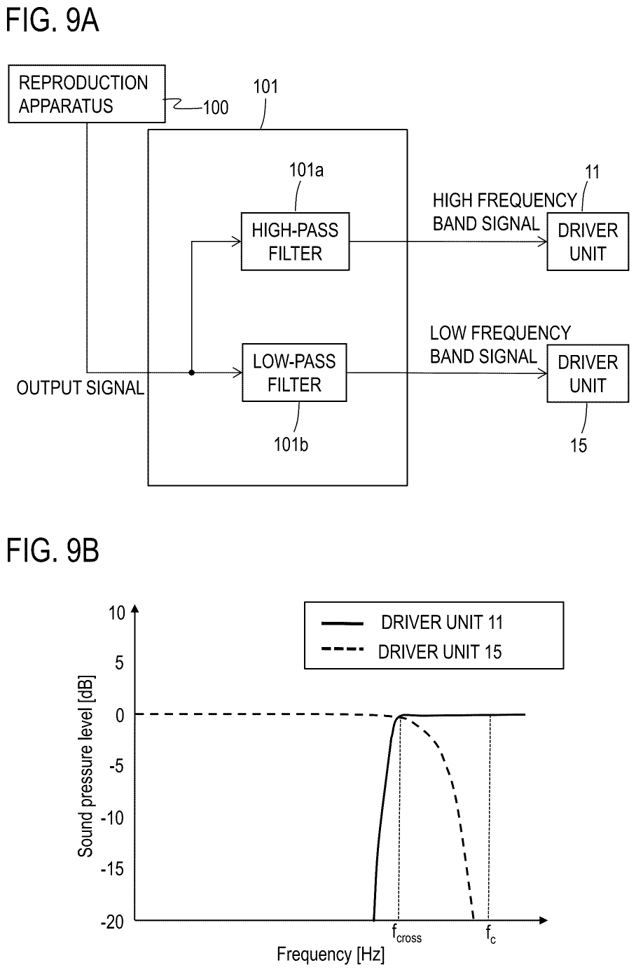

As illustrated in FIG. 9A, the output signal output from a reproduction apparatus 100 is input to a signal separation apparatus 101. The signal separation apparatus 101 separates the input output signal into a high frequency band signal on the high-frequency side and a low frequency band signal on the low-frequency side. In the example of FIG. 9B, the output signal is branched into two, and the branched output signals are input to a high-pass filter 101a and a low-pass filter 101b, respectively. The high-pass filter 101a attenuates the low-frequency side of the input output signal to obtain and output a high frequency band signal. The low-pass filter 101b attenuates the high-frequency side of the input output signal to obtain and output a low frequency band signal. The high frequency band signal is input to the driver unit 11 of the sound signal output apparatus 10, and the driver unit 11 emits the sound signal AC1 to the D1 direction side and emits the sound signal AC2 to the D2 direction side. The low frequency band signal is input to the driver unit 15 of the sound signal output apparatus 10, and the driver unit 15 emits the sound signal AC3 to the D1 direction side and emits the sound signal AC4 to the D2 direction side.

As illustrated in FIG. 9B, in the present embodiment, the crossover frequency is set to f_{cross}, the driver unit 11 emits the sound signals AC1 and AC2 in the high frequency band having a sufficient sound pressure at a frequency higher than or equal to the crossover frequency f_{cross}, and the driver unit 15 emits the sound signals AC3 and AC4 in the low frequency band having a sufficient sound pressure at a frequency lower than or equal to the crossover frequency f_{cross}. That is, the low-pass filter 101b outputs a signal in the low frequency band having a sufficient sound pressure at a frequency lower than or equal to the crossover frequency f_{cross}. In addition, the high-pass filter 101a outputs a signal in the high frequency band having a sufficient sound pressure at a frequency higher than or equal to the crossover frequency f_{cross}. At this time, the crossover frequency f_{cross} is desirably set to be lower than the cutoff frequency f_{c} of the speaker including the driver unit 11 and the reflector 13 represented by Equation (5). That is, the crossover frequency f_{cross} between the high frequency band and the low frequency band is desirably lower than the cutoff frequency f_{c} represented by Equation (5). For example, an example of the crossover frequency f_{cross} is 1000 [Hz] or the vicinity thereof, and the cutoff frequency f_{c} is a frequency higher than 1000 [Hz]. Thus, a sufficient sound pressure is obtained in the high frequency band. Note that the crossover frequency f_{cross} and the cutoff frequency f_{c} are only required to be determined so as to obtain a full band signal having desired frequency characteristics at the user's listening point located on the D1 direction side.

### Experiment Results

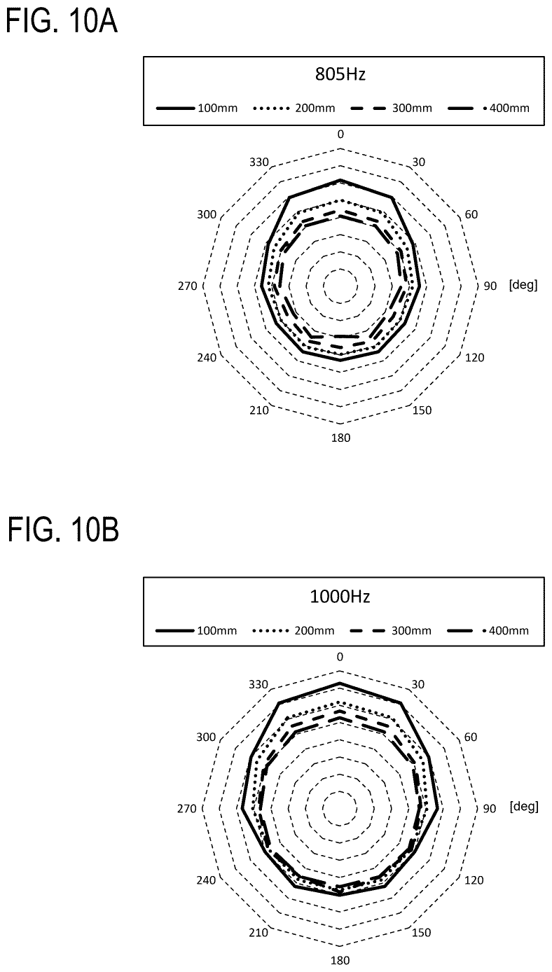

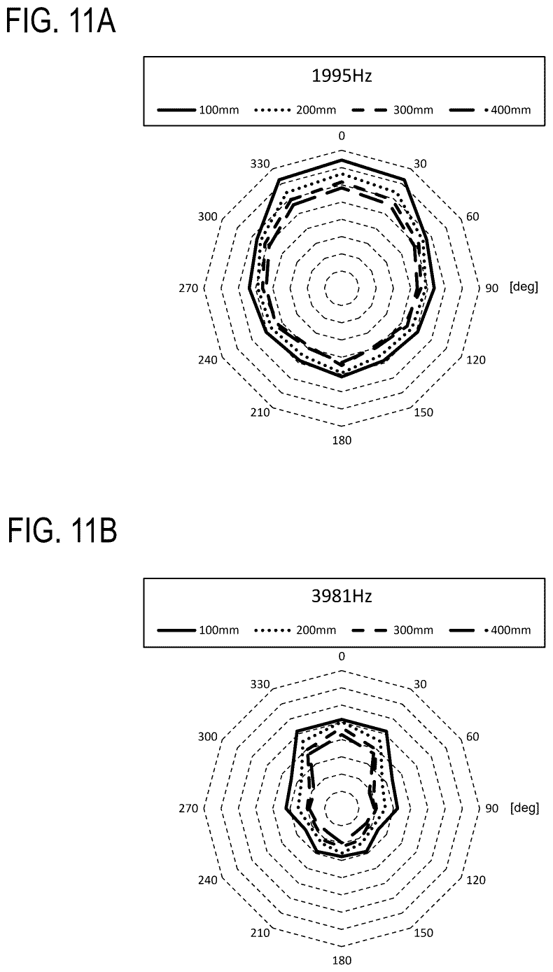

Experimental results will be provided below. FIGS. 10A, 10B, 11A, 11B, and 12 illustrate graphs (radar charts) representing sound pressures at frequencies of 805 Hz, 1000 Hz, 1995 Hz, 3981 Hz, and 7943 Hz of the sound signals measured around the sound signal output apparatus 10 of the present embodiment, respectively. 0 [deg] represents the D1 direction, 180 [deg] represents the D2 direction, and lines represent sound pressure levels at positions 100 mm, 200 mm, 300 mm, and 400 mm away from the sound signal output apparatus 10 in the respective directions. In these graphs, the closer to the center, the lower the sound pressure level, and the closer to the outside, the higher the sound pressure level.

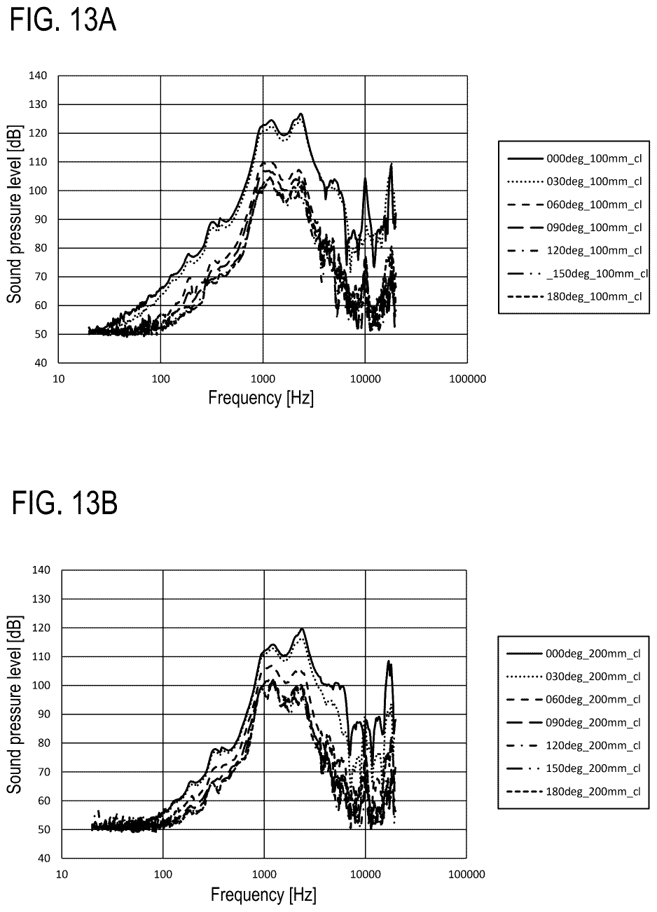

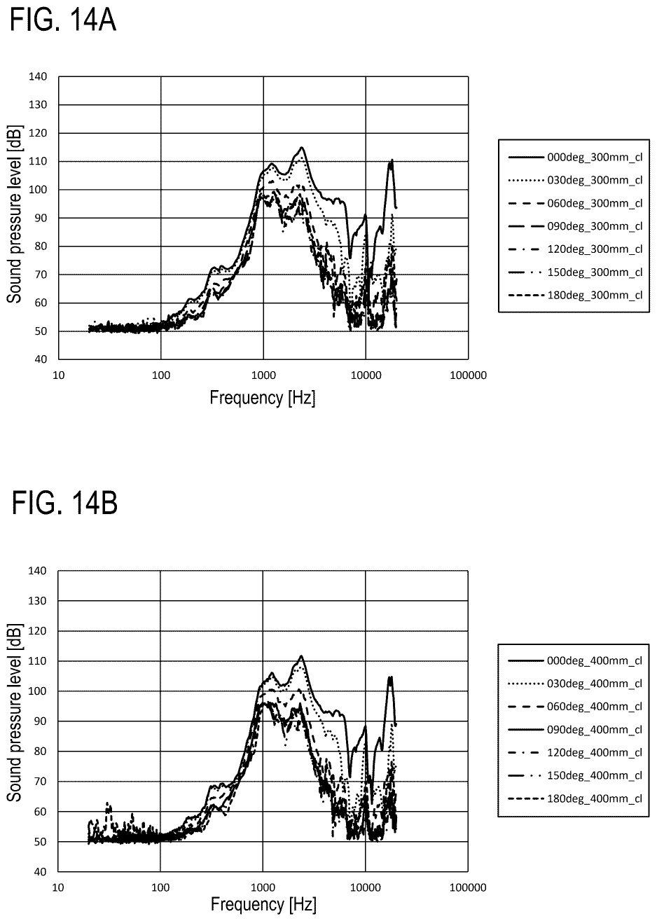

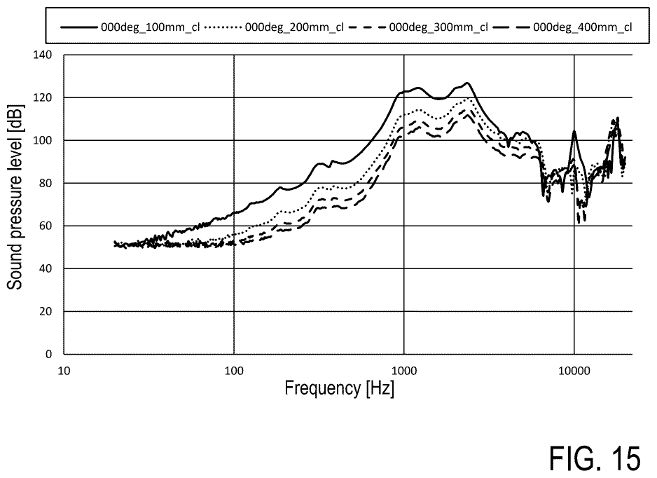

FIGS. 13A to 15 illustrate graphs representing frequency characteristics of a sound signal measured around the sound signal output apparatus 10 of the present embodiment. The horizontal axis of these graphs represents frequency [Hz], and the vertical axis represents sound pressure level [dB]. Each line represents a sound pressure level [dB] in each direction [deg] and at each relative position [mm] with respect to the sound signal output apparatus 10. “aaa deg_bbb mm_cl” in the legends of these graphs represents the sound pressure level [dB] measured at the position where the direction with respect to the sound signal output apparatus 10 is aaa [deg] and the relative position is bbb [mm].

As described above, in the sound signal output apparatus 10 of the present embodiment, it is possible to sufficiently suppress sound leakage to other positions while securing a sufficient sound pressure in a specific area on the D1 direction side in a wide frequency band. In particular, due to the directivity of the reflector 13, the sound leakage to other positions can be sufficiently suppressed while securing a sufficient sound pressure in a specific area on the D1 direction side even at a high frequency exceeding 1000 Hz. As described above, in the present embodiment, sound leakage to the surroundings can be suppressed in a wide frequency band including high frequencies.

### First Modification Example of First Embodiment

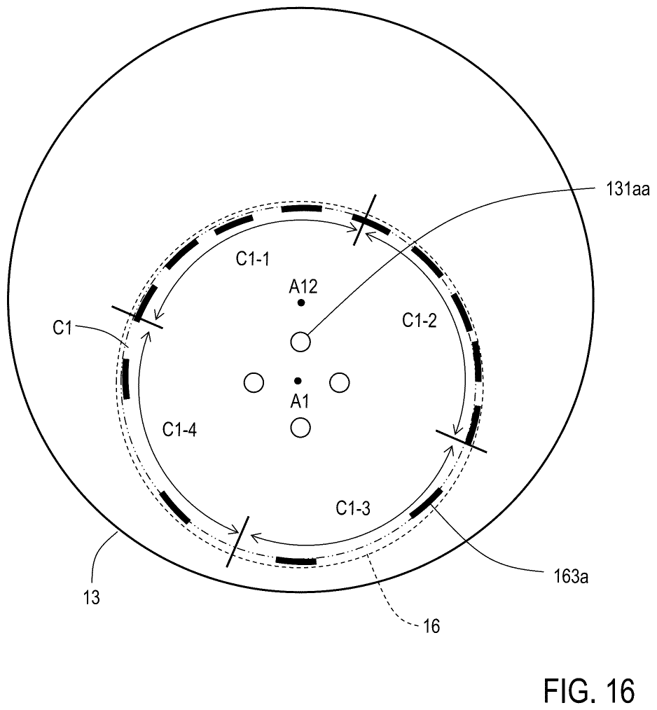

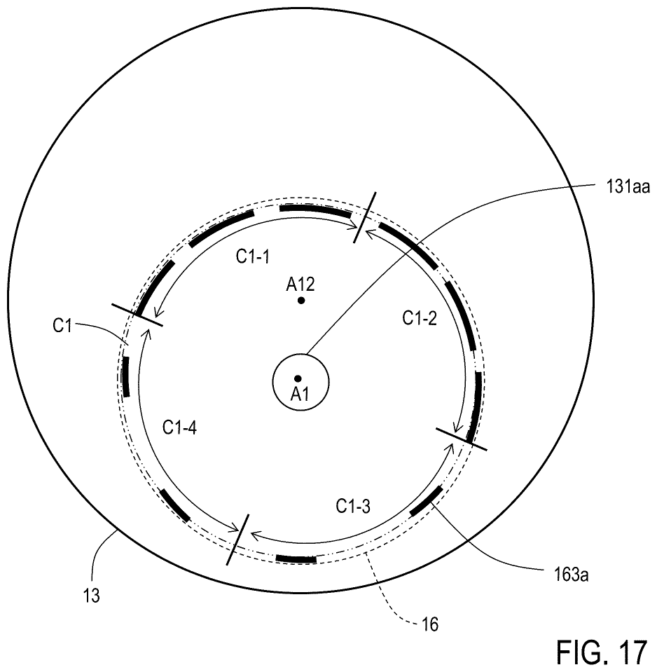

Hereinafter, description will focus on differences from the matters described so far, and description of portions that have already been described will be simplified. As described above, the single sound hole 161a may be provided in the area AR1 of the wall portion 161 of the housing 16, or the plurality of sound holes 161a may be provided, or the single sound hole 131aa connected to the sound hole 161a may be provided on the bottom portion 131a side of the reflector 13, or the plurality of sound holes 131aa may be provided. In addition, the reflector 13 may be biased to an eccentric position (a position on an axis A12 parallel to the axis A1 and deviated from the axis A1) deviated from the center (center position) of the housing 16 (hereinafter, simply referred to as an “eccentric position”). For example, as illustrated in FIG. 16, the center of the plurality of sound holes 161a and 131aa may be disposed on the axis A1, and the reflector 13 may be biased on the axis A12. Alternatively, as illustrated in FIG. 17, one sound hole 161a and one sound hole 131aa may be disposed on the axis A1, and the reflector 13 may be biased on the axis A12. In other words, the reflector 13 may be disposed to be biased with respect to the housing 16, one sound hole 161a, and one sound hole 131aa.

In a case where the reflector 13 is disposed to be biased with respect to the housing 16, one sound hole 161a and one sound hole 131aa, the distribution and opening area of the sound hole 163a may be biased accordingly. In the example of FIG. 16, the number of sound holes 163a provided along the unit arc areas C1-3 and C1-4 distant from the axis A12 is smaller than the number of sound holes 163a provided along the unit arc areas C1-1 and C1-2 closer to the axis A12. In the example of FIG. 17, the opening area of each of the sound holes 163a provided along the unit arc areas C1-3 and C1-4 distant from the axis A12 is smaller than the opening area of each of the sound holes 163a provided along the unit arc areas C1-1 and C1-2 closer to the axis A12. That is, in a case where the circumference C1 is equally divided into a plurality of unit arc areas, the sum of the opening areas of the sound holes 163a (second sound holes) provided along the first arc area (for example, C1-3 or C1-4) that is one of the unit arc areas is smaller than the sum of the opening areas of the sound holes 163a provided along the second arc area (for example, C1-1 or C1-2) that is one of the unit arc areas closer to the axis A12 than the first arc area. In a case where the reflector 13 is disposed to be biased to an eccentric position, the distribution of the sound signal AC3 emitted from the open end 130 of the reflector 13 to the outside is also biased to the eccentric position. Here, the distribution and the opening areas of the sound holes 163a are also made biased to the eccentric position, and thus the distribution of the sound signal AC4 emitted from the sound holes 163a to the outside can also be biased to the eccentric position. Thus, the sound leakage component of the sound signal AC3 can be sufficiently canceled out by the emitted sound signal AC4.

### Second Modification Example of First Embodiment

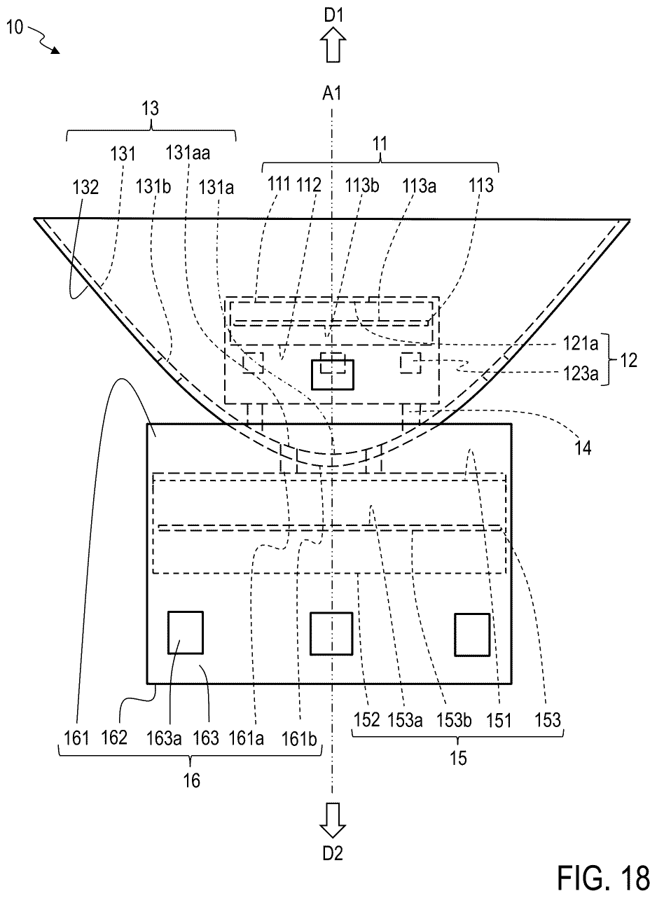

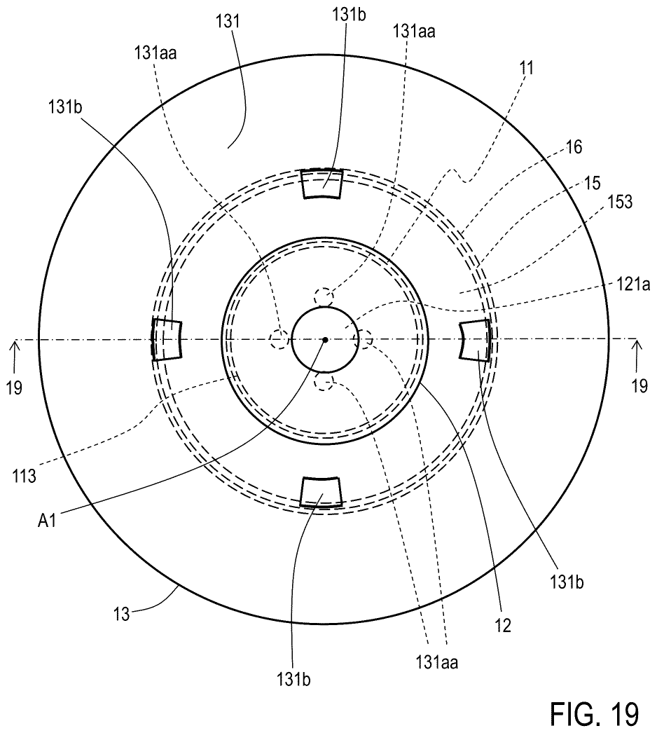

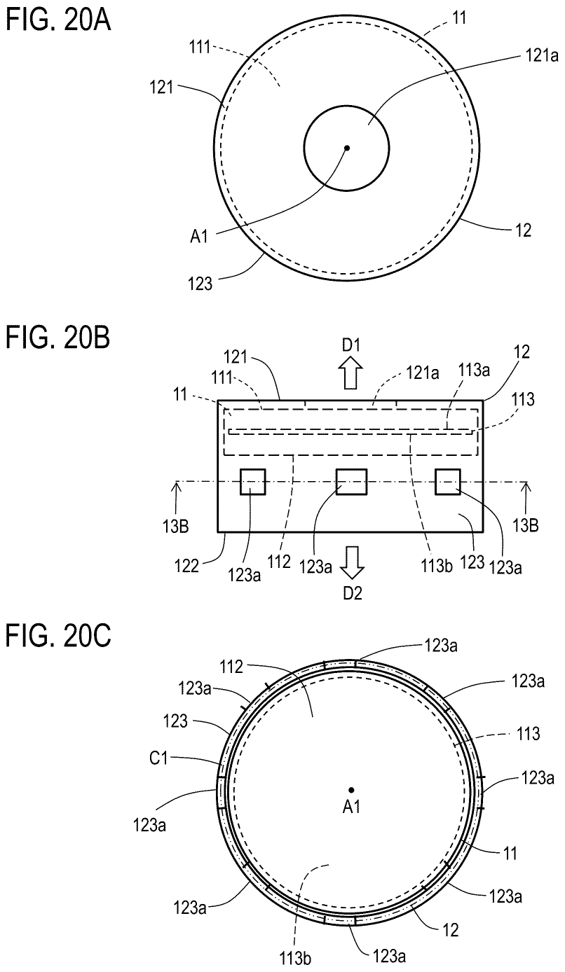

As illustrated in FIGS. 18 to 21, in the first embodiment or the first modification example thereof, the driver unit 11 (first driver unit) may be accommodated in a housing 12 (first housing) different from the housing 16 (second housing), and the housing 12 accommodating the driver unit 11 in this manner may be disposed inside the reflector 13.

### <Housing 12>

The housing 12 is a hollow member having a wall portion on the outer side, sound holes 121a and 123a are provided in the wall portion, and the driver unit 11 is accommodated inside. For example, the driver unit 11 is fixed to an end portion on the D1 direction side inside the housing 12. Although the shape of the housing 12 is not limited, for example, the shape of the housing 12 is desirably rotationally symmetric (axially symmetric) or substantially rotationally symmetric relative to the axis A1. Thus, it is easy to provide the sound holes 123a so as to reduce variation in each direction of the energy of the sound signal emitted from the housing 12. For example, the housing 12 includes a first end surface that is a wall portion 121 disposed on one side (D1 direction side) of the driver unit 11, a second end surface that is a wall portion 122 disposed on the other side (D2 direction side) of the driver unit 11, and a side surface that is a wall portion 123 surrounding a space sandwiched between the first end surface and the second end surface about the axis A1 passing through the first end surface and the second end surface. Here, for simplification of description, an example is described in which the housing 12 has a substantially cylindrical shape including both end surfaces. However, these are examples and do not limit the present invention. For example, the housing 12 may have a substantially dome shape including a wall portion at an end portion, or may have a hollow substantially cubic shape, or may have another three-dimensional shape. In addition, the material of the housing 12 is not limited. The housing 12 may be formed of a rigid body such as synthetic resin or metal or may be formed of an elastic body such as rubber.

<Sound Holes 121a and 123a>

As described above, the wall portion of the housing 12 includes a sound hole 121a (first sound hole) for leading out the sound signal AC1 (first sound signal) emitted from the driver unit 11 to the outside (inside of the reflector 13) and sound holes 123a (second sound holes) for leading out the sound signal AC2 (second sound signal) emitted from the driver unit 11 to the outside (inside of the reflector 13). The sound hole 121a and the sound holes 123a are, for example, through holes penetrating the wall portion of the housing 12, but this does not limit the present invention. As long as the sound signal AC1 and the sound signal AC2 can be led out to the outside (inside of the reflector 13), the sound hole 121a and the sound holes 123a may not be through holes.

An arrangement configuration of the sound holes 121a and 123a will be exemplified.

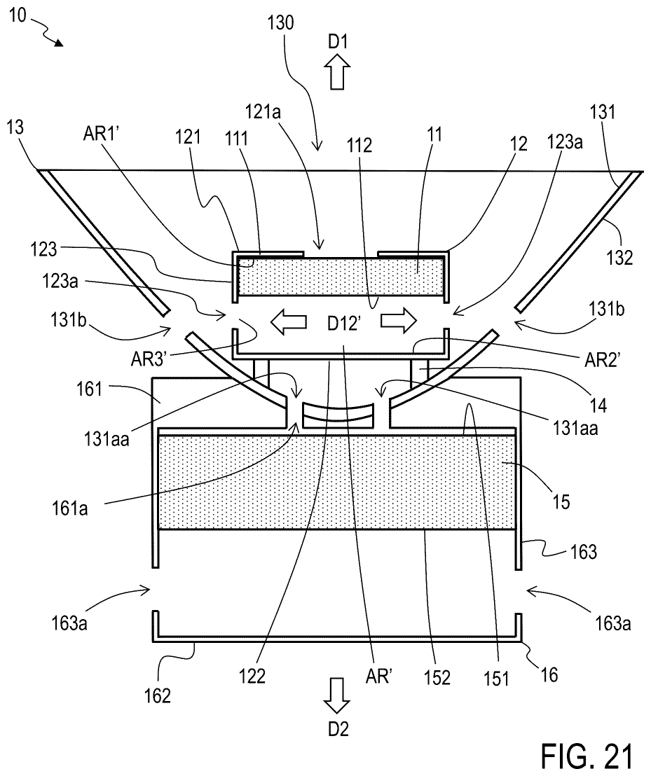

The sound hole 121a (first sound hole) exemplified here is provided in the area AR1 (first area) of the wall portion 121 disposed on one side (D1 direction side that is a side to which the sound signal AC1 is emitted) of the driver unit 11 (FIGS. 18, 19, 20A, 20B, and 21). That is, the sound hole 121a is opened in the D1 direction (first direction) along the axis A1. In addition, the sound holes 123a (second sound holes) exemplified here are provided in an area AR3′ of the wall portion 123 that is in contact with an area AR′ between an area AR1′ of the wall portion 121 of the housing 12 and an area AR2′ of the wall portion 122 disposed on the D2 direction side (the other side that is a side to which the sound signal AC2 is emitted) of the driver unit 11. That is, assuming that a direction between the D1 direction (first direction) and the opposite direction of the D1 direction is a D12′ direction (second direction) using the center of the housing 12 as a reference (FIG. 21B), the sound hole 121a (first sound hole) is provided on the D1 direction side (first direction side) of the housing 12, and the sound holes 123a (second sound holes) are provided on the D12′ direction side (second direction side) of the housing 12. For example, in a case where the housing 12 includes a wall portion 121 disposed on one side (D1 direction side) of the driver unit 11, a wall portion 122 disposed on the other side (D2 direction side) of the driver unit 11, and a wall portion 123 (side surface) surrounding the space sandwiched between the wall portion 121 and the wall portion 122 about the axis A1 along the emission direction (D1 direction) of the sound signal AC1 passing through the wall portion 121 and the wall portion 122 (FIG. 18), the sound hole 121a (first sound hole) is provided in the wall portion 121, and the sound holes 123a (second sound holes) are provided in the wall portion 123 (side surface).

As illustrated in FIG. 18A, and the like, the sound hole 121a exemplified here is disposed on or near the axis A1 along the emission direction (D1 direction) of the sound signal AC1. That is, the sound hole 121a of this example is provided at the center position of the area AR1 of the wall portion 121 of the housing 12. In this example, for simplification of description, an example is described in which the shape of the edge of the open end of the sound hole 121a is a circle (the open end is a circle). However, this does not limit the present invention. For example, the shape of the edge of the open end of the sound hole 121a may be another shape such as an ellipse, a quadrangle, and a triangle. In addition, the open end of the sound hole 121a may have a mesh shape. In other words, the open end of the sound hole 121a may be formed by a plurality of holes. In addition, in this example, for simplification of description, an example is described in which one sound hole 121a is provided in the area AR1 (first area) of the wall portion 121 of the housing 12. However, this does not limit the present invention. For example, two or more sound holes 121a may be provided in the area AR1 (first area) of the wall portion 121 of the housing 12.

A plurality of sound holes 123a (second sound holes) is desirably provided along a circumference (circle) C1 about the axis A1 along the emission direction of the sound signal AC1 (first sound signal). Here, for simplification of description, an example is described in which a plurality of sound holes 123a is provided on the circumference C1. However, a plurality of sound holes 123a is only required to be provided along the circumference C1, and not all the sound holes 123a need to be strictly disposed on the circumference C1.

In addition, preferably, in a case where the circumference C1 is equally divided into a plurality of unit arc areas, the sum of the opening areas of sound holes 123a (second sound holes) provided along the first arc area that is one of the unit arc areas is the same as or substantially the same as the sum of the opening areas of sound holes 123a (second sound holes) provided along the second arc area that is one of the unit arc areas excluding the first arc area.

More preferably, a plurality of sound holes 123a having the same shape, the same size, and the same interval is desirably provided along the circumference C1. In a case where a plurality of sound holes 123a having the same shape, the same size, and the same interval is provided along the circumference C1, the sound leakage component of the sound signal AC1 can be more appropriately canceled out by the sound signal AC2. However, this does not limit the present invention.

Here, for simplification of description, a case where the shape of the edge of the open end of the sound hole 123a is a quadrangle (a case where the open end is a rectangle) is exemplified, but this does not limit the present invention. For example, the shape of the edge of the open end of the sound hole 123a may be another shape such as a circle, an ellipse, and a triangle. In addition, the open end of the sound hole 123a may have a mesh shape. In other words, the open end of the sound hole 123a may be formed by a plurality of holes. In addition, the number of sound holes 123a is not limited, and a single sound hole 123a may be provided in the area AR3 of the wall portion 123 of the housing 12, or a plurality of sound holes 123a may be provided.

The housing 12 is fixed to the inner wall surface 131 of the reflector 13 via the support portion 14. In the present embodiment, the sound hole 121a side of the housing 12 disposed inside the reflector 13 is directed to the open end 130 side (D1 direction side) of the reflector 13, and the wall portion 122 on the other side is directed to the bottom portion 131a side (D2 direction side) of the reflector 13. Preferably, at least some of the sound holes 123a of the housing 12 are desirably provided at positions facing the sound holes 131b of the reflector 13.

### Third Modification Example of First Embodiment

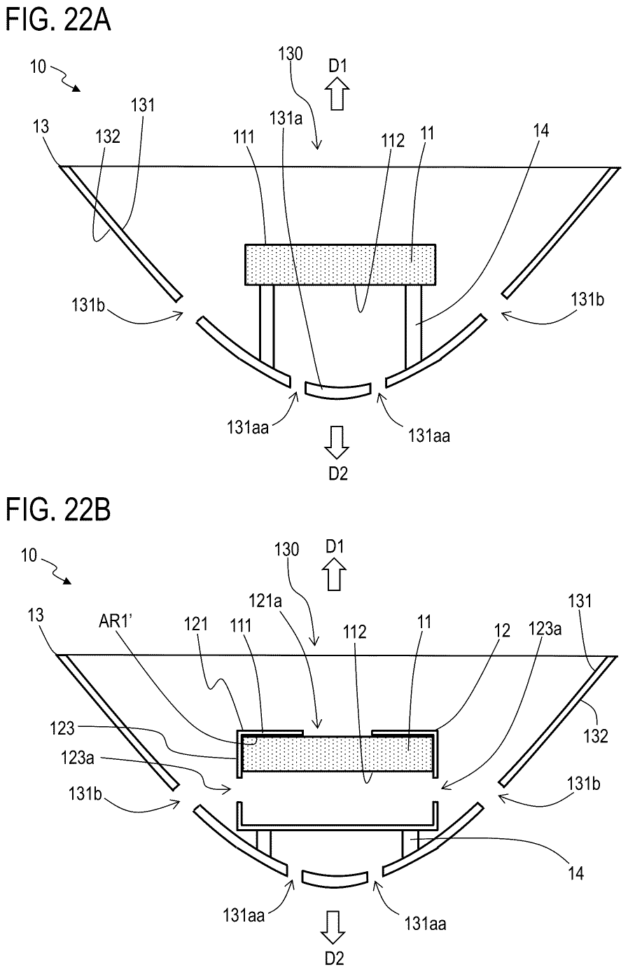

As illustrated in FIGS. 22A and 22B, in the first embodiment and the first and second modification examples thereof, the housing 16 and the driver unit 15 (second driver unit) may be omitted. In this case, the sound holes 131aa may be omitted.

### Second Embodiment

In the first embodiment and the modification examples thereof, instead of the sound holes 131b or in addition to the sound holes 131b, a cutout portion (slit portion) 231b that opens the inside of the reflector 13 to the outside may be provided on a part of the open end 130 side of the reflector 13. As described above, the sound signal AC1 and the sound signal AC2 are emitted from the open end 130 of the reflector 13. Here, the sound signal AC2 is an antiphase signal of the sound signal AC1 or an approximate signal of the antiphase signal. Therefore, at a specific position P22 on the D1 direction side other than a position P21 where the user is present, a part of the sound signal AC1 cancels out a part of the sound signal AC2, and thus the sound leakage of the sound signal AC1 at the position P22 is suppressed. However, in the high-frequency components of the sound signals AC1 and AC2, the high-frequency components are difficult to cancel out each other, and conversely, at the position P22, the sound signal AC2 may enhance the sound signal AC1 and promote the sound leakage. On the other hand, by providing the cutout portion 231b on a part of the open end 130 side of the reflector 13, the sound leakage at the position P22 can be suppressed. The level of the sound pressure of the sound signal AC2 at the position P22 can be lowered by increasing the size of the cutout portion 231b. Therefore, the size of the cutout portion 231b is only required to be designed such that the sound pressure of the sound signal AC2 (second sound signal) at the specific position P22 in the direction of the open end 130 of the reflector 13 becomes less than or equal to a predetermined level. For example, the size of the cutout portion 231b is only required to be designed such that the sound pressure of the sound signal AC2 (second sound signal) at a predetermined frequency or more at the position P22 becomes less than or equal to a predetermined level. The cutout portion 231b will be exemplified below.

### First Example of Cutout Portion 231b (Cutout Portion 231b-SW)

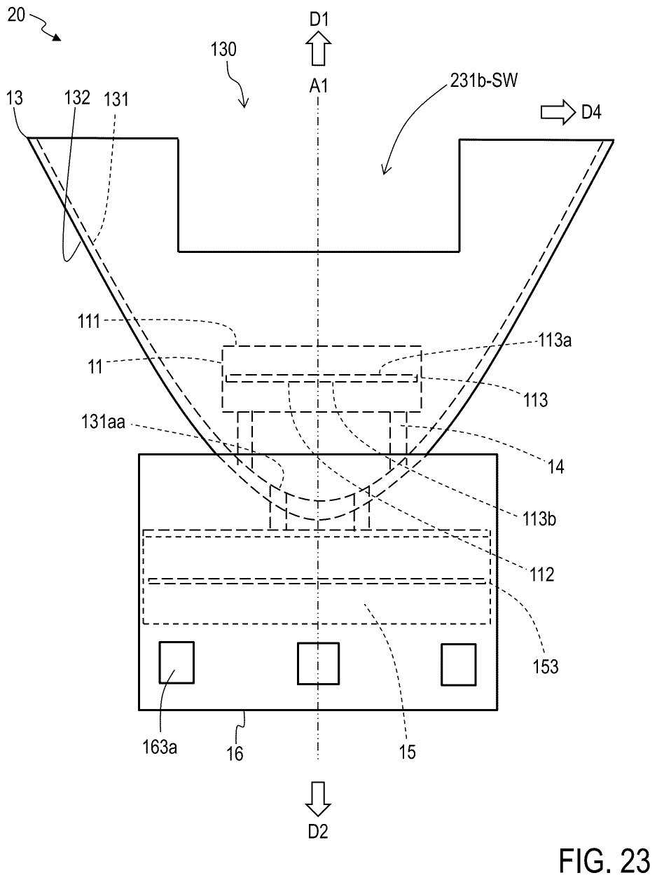

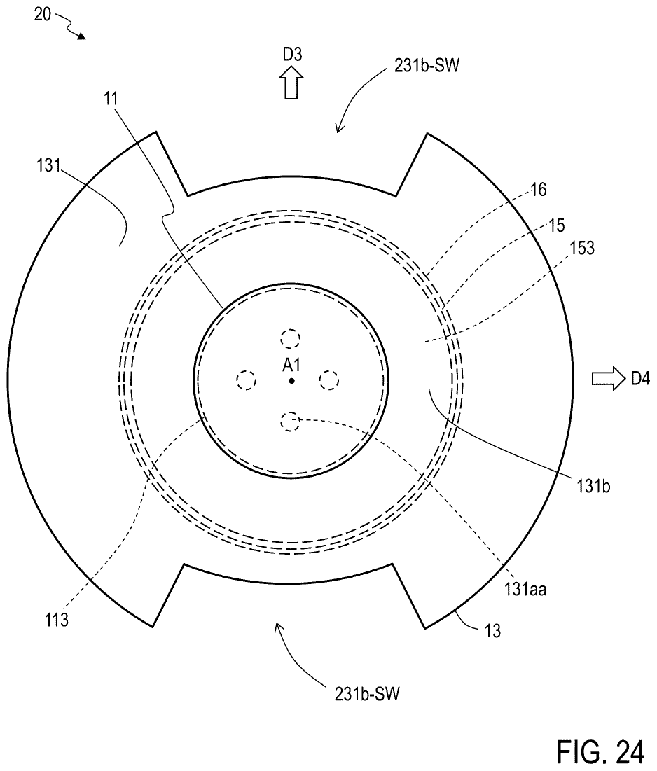

In a sound signal output apparatus 20 illustrated in FIGS. 23 and 24, instead of the sound holes 131b, a horizontally long cutout portion 231b-SW that opens the inside of the reflector 13 to the outside is provided on a part of the open end 130 side of the reflector 13. That is, the shape of the cutout portion 231b-SW in this example is long in a D4 direction that is orthogonal to a D1-D2 direction rather than in the D1-D2 direction.

### Second Example of Cutout Portion 231b (Cutout Portion 231b-LW)

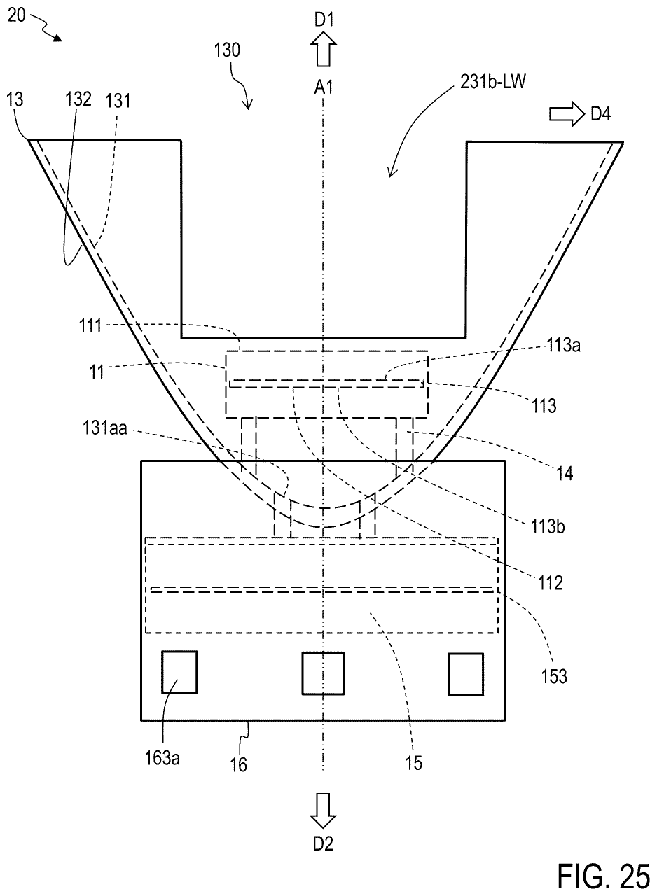

In the sound signal output apparatus 20 illustrated in FIG. 25, instead of the sound holes 131b, a vertically and horizontally large cutout portion 231b-LW that opens the inside of the reflector 13 to the outside is provided on a part of the open end 130 side of the reflector 13. That is, the length of the cutout portion 231b-LW of this example in the D1-D2 direction is the same as the length of the cutout portion 231b-SW in the D1-D2 direction in FIG. 23, but the length of the cutout portion 231b-LW in the D4 direction is longer than the length of the cutout portion 231b-SW in the D4 direction.

### Third Example of Cutout Portion 231b (Cutout Portion 231b-LN)

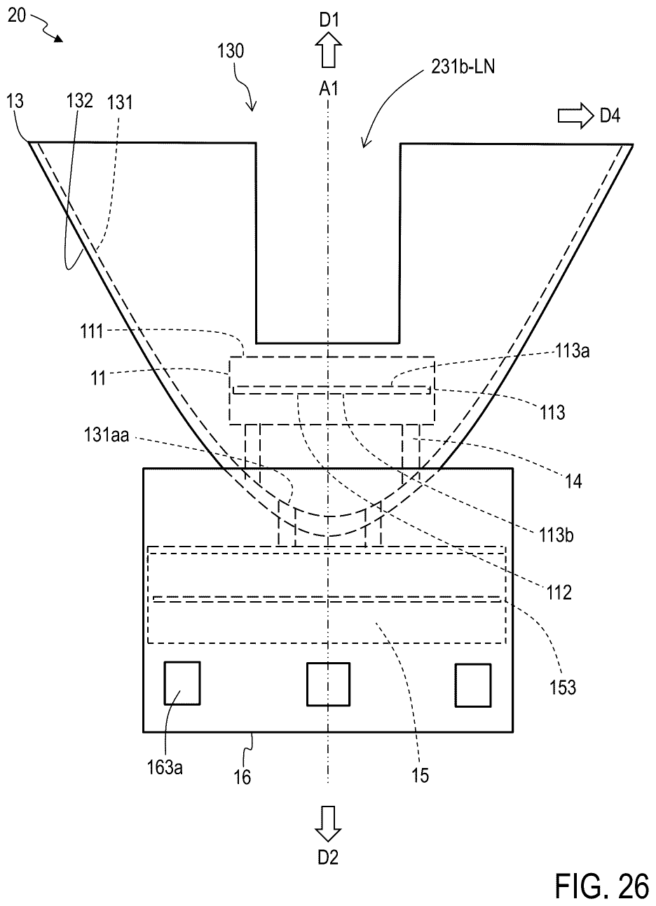

In the sound signal output apparatus 20 illustrated in FIG. 26, instead of the sound holes 131b, a vertically long cutout portion 231b-LN that opens the inside of the reflector 13 to the outside is provided on a part of the open end 130 side of the reflector 13. That is, the length of the shape of the cutout portion 231b-LN of this example in the D1-D2 direction is the same as the length of the cutout portion 231b-LW in the D1-D2 direction in FIG. 25, but the length of the cutout portion 231b-LN in the D4 direction is longer than the length of the cutout portion 231b-LW in the D4 direction.

### Experiment Results

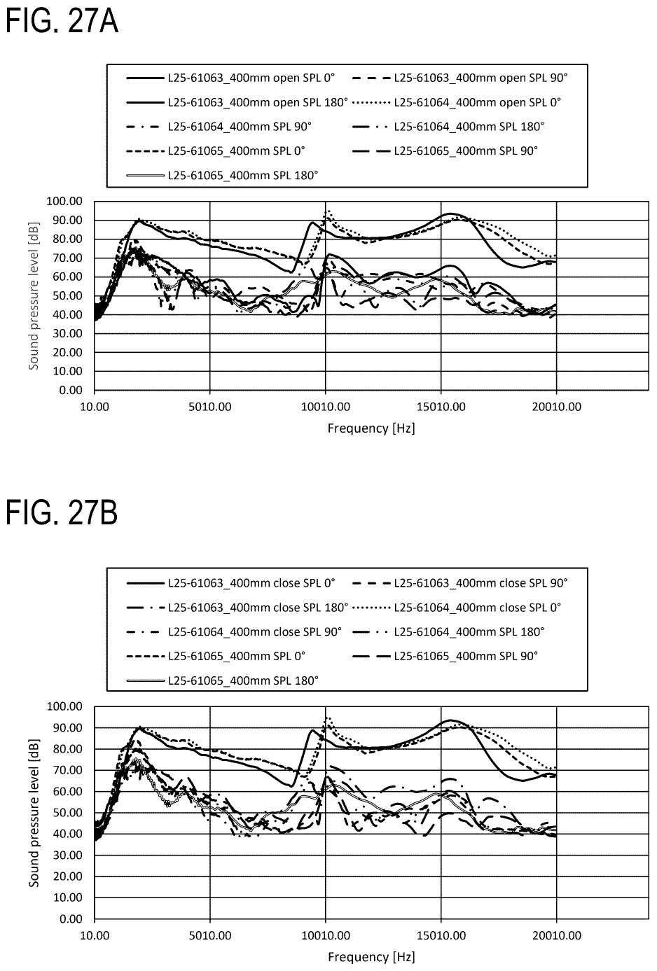

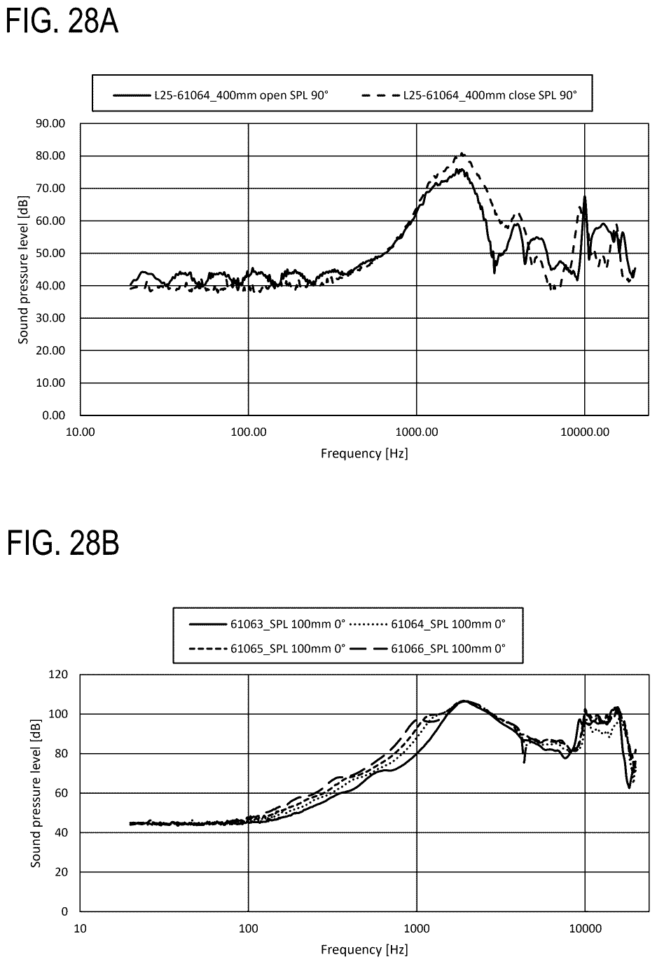

FIGS. 27 and 28 illustrate experiment results. The vertical axis represents sound pressure level [dB], and the horizontal axis represents frequency [Hz]. “L25-aaaaa bbb mm. open SPL c°” in the legends represents the sound pressure measured outside (FIG. 24) on the D3 direction side (cutout portion 231b side) of the sound signal output apparatus 20. On the other hand, “L25-aaaaa bbb mm. close SPL c°” represents the sound pressure measured outside on the D4 direction side of the sound signal output apparatus 20 (the side on which the cutout portion 231b is not provided). A line with “L25-aaaaa” being “L25-61065” represents a measurement result of the sound signal output apparatus 20 provided with the cutout portion 231b-SW (FIG. 24). A line with “L25-aaaaa” being “L25-61063” represents a measurement result of the sound signal output apparatus 20 provided with the cutout portion 231b-LW (FIG. 25). A line with “L25-aaaaa” being “L25-61064” represents a measurement result of the sound signal output apparatus 20 provided with the cutout portion 231b-LN (FIG. 26). “bbb mm” represents a distance from the sound signal output apparatus 20 to the measurement position. “c°” represents the direction of the measurement position with respect to the sound signal output apparatus 20. “c°” being 0° represents that the direction of the measurement position with respect to the sound signal output apparatus 20 is the D1 direction. “c°” being 90° represents that the direction of the measurement position with respect to the sound signal output apparatus 20 is a direction orthogonal to the D1-D2 direction. “c°” being 180° represents that the direction of the measurement position with respect to the sound signal output apparatus 20 is the D2 direction.

As illustrated in these figures, it can be seen that sound leakage can be adjusted by the size and shape of the cutout portion 231b.

Note that, in addition to the sound holes 131b described above, the vertically long cutout portion 231b-LN that opens the inside of the reflector 13 to the outside may be provided on a part of the open end 130 side of the reflector 13.

### Third Embodiment

In the first embodiment, the first and second modification examples thereof, and the second embodiment, a part of the reflector 13 may be used as a diaphragm of a driver unit (second driver unit). Thus, the size can be reduced as a whole. A specific example will be described below.

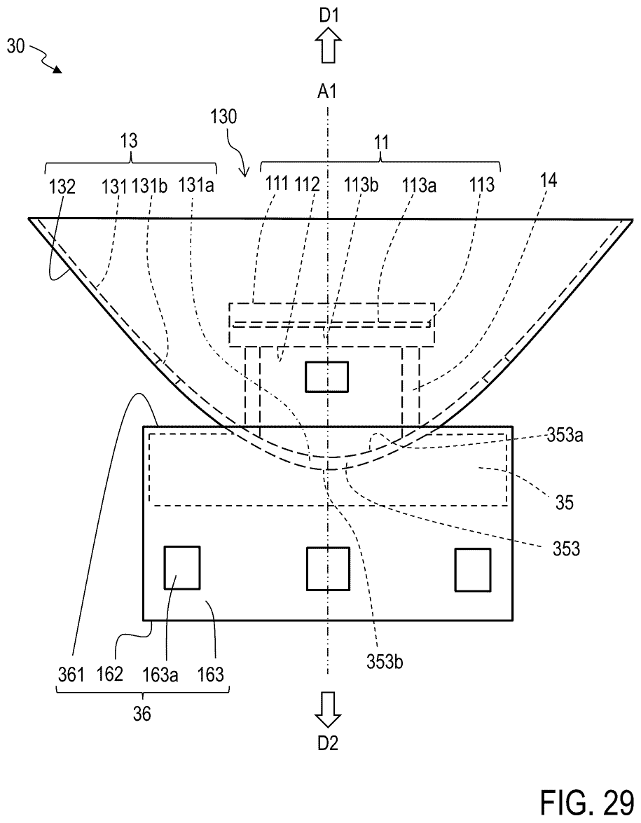

A sound signal output apparatus 30 illustrated in FIG. 29 includes a concave reflector 13 that has a rotational paraboloid or a surface approximate to the rotational paraboloid inside, driver units 11 and 35 (a speaker driver unit and a driver) that convert an output signal output from a reproduction apparatus into a sound signal and output the sound signal, a housing 36 that accommodates the driver unit 35 therein, and a support portion 14 for disposing the driver unit 11 inside the reflector 13. However, the reflector 13 is disposed on a wall portion 361 side of the housing 36 in the D1 direction, and the bottom portion 131a (a part) of the reflector 13 also functions as a diaphragm 353 of the driver unit 35. That is, the driver unit 35 emits the sound signal AC3 (third sound signal) from (one) surface 353a on the D1 direction side to the D1 direction side (one side) when the diaphragm 353 that is the bottom portion 131a of the reflector 13 vibrates, and emits the sound signal AC4 (fourth sound signal) from the other surface 353b to the D2 direction side (the other side) by the vibration. Thus, the size of the sound signal output apparatus 30 in the D1-D2 direction can be reduced. Preferably, it is desirable that at least a part of the inner wall surface 131 of the reflector 13 is a rotational paraboloid or a surface approximate to the rotational paraboloid, and this rotational paraboloid has a shape formed by rotating a parabola about the axis A1 (a specific axis), and the diaphragm 353 is the bottom portion 131a portion of the reflector 13 disposed on the axis A1 or near the axis A1. Thus, the sound pressure of the sound signal AC3 emitted from the open end 130 of the reflector 13 is axially symmetric or substantially axially symmetric relative to the axis A1. In addition, it is desirable that one or a plurality of sound holes 131b (reflector sound holes) is provided at positions excluding the diaphragm 353 of the reflector 13. Thus, the sound signals AC3 and AC4 having high sound pressures can be emitted from the diaphragm 353.

Note that FIG. 29 illustrates an example in which the driver unit 11 is not accommodated in the housing 12. However, the driver unit 11 (first driver unit) may be accommodated in a housing 12 (first housing) different from the housing 36 (second housing), and the housing 12 accommodating the driver unit 11 in this manner may be disposed inside the reflector 13 (see the second modification example of the first embodiment).

### Other Modification Example

Note that the present invention is not limited to the above-described embodiments. For example, in the first and second embodiments and the modification examples thereof described above, an example in which the bottom portion 131a side of the reflector 13 is fixed to the wall portion 161 of the housing 16 has been described, but the bottom portion 131a side of the reflector 13 may be integrated with the wall portion 161 of the housing 16.

In addition, it is desirable that the driver unit 11 is disposed at or near the focal point of the rotational paraboloid of the reflector 13, but the driver unit 11 may be disposed at other positions. For example, the driver unit 11 may be attached to the bottom portion 131a side of the reflector 13.

In addition, the reflector 13 may have a horn shape or other shapes.

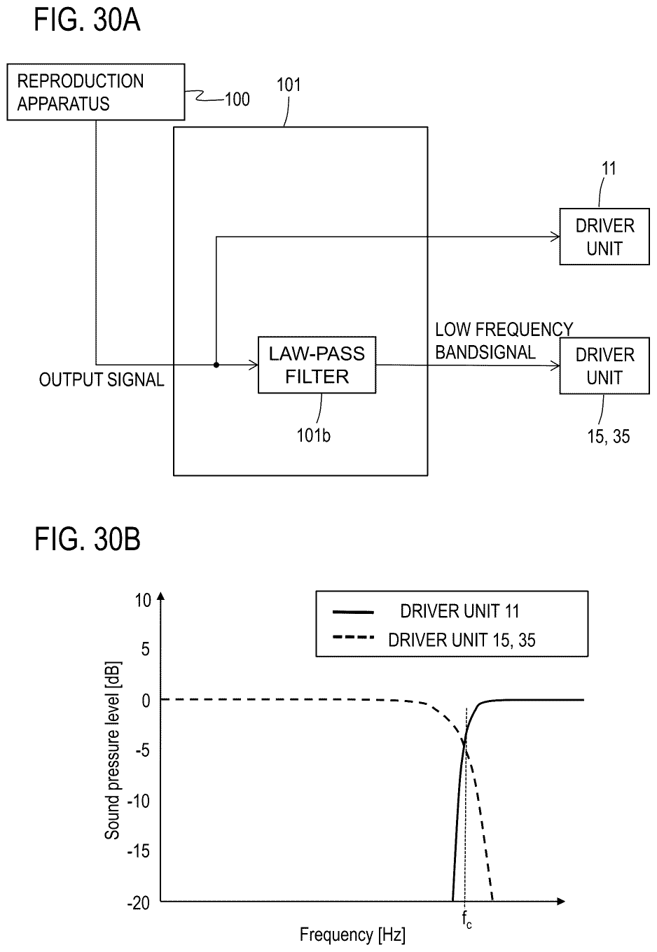

In the above-described embodiments and the modification examples thereof, the high-pass filter 101a may be omitted from the signal separation apparatus 101 illustrated in FIG. 9A. Since the sound signals AC1 and AC2 emitted from the driver unit 11 are likely to be canceled out by mutual interference in the band on the medium-low frequency side, the sound pressure levels on the medium-low frequency side in the sound signal AC1 and the sound signal AC2 at the measurement point decrease. On the other hand, since the sound signals AC1 and AC2 do not sufficiently cancel out each other on the high-frequency side, the sound pressure levels on the high-frequency side in the sound signal AC1 and the sound signal AC2 at the measurement point are high. This feature serves a role equivalent to that of the high-pass filter. Therefore, even when the high-pass filter 101a is omitted from the signal separation apparatus 101, the sound pressure levels in the sound signal AC1 and the sound signal AC2 measured at the measurement point are suppressed on the medium-low frequency side and are not suppressed so much on the high-frequency side (FIG. 30B). This effect is particularly remarkable in a case where the driver unit 11 is accommodated inside the housing 12 provided with the sound holes 121a and 123a as described above (for example, the second modification example of the first embodiment). Therefore, in particular, in a case where the driver unit 11 is accommodated inside the housing 12 provided with the sound holes 121a and 123a, even when the high-pass filter 101a is omitted, the influence on the characteristics is small.

In the case of such a configuration, the output signal output from the reproduction apparatus 100 is input to the signal separation apparatus 101, and the signal separation apparatus 101 branches the input output signal into two. The branched output signals are input to the driver unit 11 and the low-pass filter 101b, respectively. The driver unit 11 emits the sound signal AC1 to the D1 direction side and emits the sound signal AC2 to the D2 direction side on the basis of the input output signal. The low-pass filter 101b attenuates the high-frequency side of the input output signal to obtain and output a low frequency band signal. The low frequency band signal is input to any of the driver unit 15 or 35 of the sound signal output apparatuses 10 to 30, and the driver unit 15 or 35 emits the sound signal AC3 to the D1 direction side and emits the sound signal AC4 to the D2 direction side.

### Fourth Embodiment

Hereinafter, the sound signal output system according to an embodiment of the present invention will be described as a fourth embodiment.

### Overall Configuration

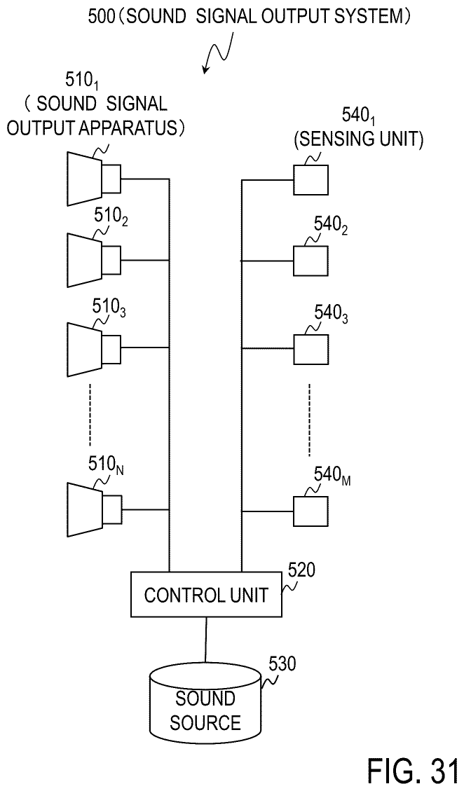

As illustrated in FIG. 31, a sound signal output system 500 according to the present embodiment includes sound signal output apparatuses 510, a control unit 520, a sound source 530, and sensing units 540.

The sound signal output apparatus 510 emits (outputs) a sound signal, and in the present embodiment, N (N≥2) sound signal output apparatuses 510 are provided and disposed in a first area T1 or the vicinity of the first area T1 as described below. In FIG. 31, the sound signal output apparatuses 510 are denoted as 510ₙ (n=1, 2, . . . , N) so that the sound signal output apparatuses can be identified.

The control unit 520 manages processing of the entire system. For example, as one function, the emission of the sound signals of the plurality of sound signal output apparatuses 510 is controlled using the sound source 530.

The sound source 530 is a sound source of a sound signal emitted by the sound signal output apparatus 510, and is sound signal data regarding a warning for notifying a person (human) present in the first area T1 to be described below, such as a message (for example, “do not approach this area because it is dangerous”) or a warning sound (for example, beep sound or the like) indicating a dangerous area. The sound source 530 has at least one piece of sound signal data. As illustrated in FIG. 31, the sound source 530 may be one of the elements constituting the sound signal output system 500, or may be provided separately from the sound signal output system 500. In addition, the sound signal data is not necessarily prepared in advance, and may be input to the sound signal output system 500 via a predetermined microphone and emitted in real time.

The sensing unit 540 senses that a human is present in a predetermined area. The sensing unit 540 includes, for example, a human sensor or an imaging apparatus such as a camera, but is not limited thereto. The number of the sensing units 540 is adjusted to M (M≥1) so as to be able to cope with sensing in a predetermined area to be measured. In FIG. 31, the sensing units 540 are denoted as 540ₘ (m=1, 2, . . . , M) so that the sensing units can be identified. The sensing unit 540 senses that a human is present in a first sub-area ST1 to be described below that at least the sensing unit 540ₘ is in charge of. Note that the sensing unit 540 is not an essential component. When no sensing function is necessary in the sound signal output system 500, the sensing unit 540 may not be provided.

### First Application Example

For example, the sound signal output system 500 is assumed to be used in a predetermined area PL that is an area including the first area T1 that is an area for indicating a warning such as being a dangerous area and the second area T2 that is an area adjacent to the first area T1 and has a lower necessity for indicating a warning than the first area T1.

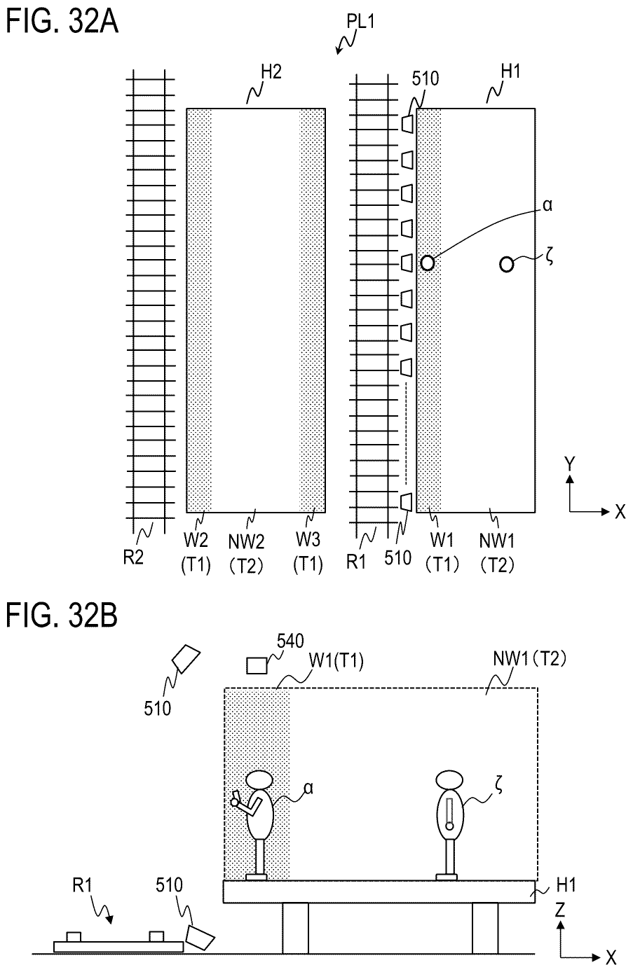

As an application example of the predetermined area PL, there is a railway station PL1 as illustrated in FIGS. 32A and 32B. The railway station PL1 has two platforms (platforms H1 and H2) and two railroad tracks (railroad tracks R1 and R2). The platform H1 includes a warning area W1 corresponding to the first area T1 for indicating a warning, and a non-warning area NW1 corresponding to the second area T2 adjacent to the first area T1 and having a lower necessity for indicating a warning than the first area T1. The platform H2 includes warning areas W2 and W3 corresponding to the first area T1 for indicating a warning, and a non-warning area NW2 corresponding to the second area T2 adjacent to the first area T1 and having a lower necessity for indicating a warning than the first area T1. In FIGS. 32A and 32B, a dot pattern is added to the first area T1. In this example, in the platforms H1 and H2, it is assumed that an area not provided with the dot pattern is the second area T2. Therefore, in these drawings, a user α is present in the warning area W1, and a user ζ is present in the non-warning area NW1.

In the first application example, the plurality of sound signal output apparatuses 510 is disposed along the vicinity of the warning area W1 in the platform H1. The sound signal output apparatuses 510 may also be disposed in the vicinity of the warning area W2 and the warning area W3. In that case, it is preferable to appropriately adjust the number, size, arrangement position, and the like of the sound signal output apparatuses 510 to be disposed in consideration of the size, shape, and the like of the platform H2.

As illustrated in FIG. 32B, the sound signal output apparatus 510 is provided in the vicinity of the railroad track R1 and is disposed to face the platform H1 present above from the place. Alternatively, as illustrated in the drawing, the sound signal output apparatus 510 is provided on the ceiling (not illustrated) and is disposed to face the platform H1 present below from the place. However, these are examples, and the arrangement position is not limited thereto.

The sensing unit 540 is provided and disposed on the ceiling, for example, as illustrated in FIG. 32B, so that it can sense that a human is present in the warning area W1 of the platform, but the arrangement position is not limited thereto. As the number of the sensing units 540 to be disposed, one sensing unit 540 may be disposed with respect to an area that one sound signal output apparatus 510 is in charge of. Alternatively, from the viewpoint of efficiency, a single sensing unit 540 may be configured to be able to cope with an area that the plurality of sound signal output apparatuses 510 is in charge of. Alternatively, for improvement of sensing accuracy, a plurality of sensing units 540 may be configured to cope with an area that one sound signal output apparatus 510 is in charge of.

### Second Application Example

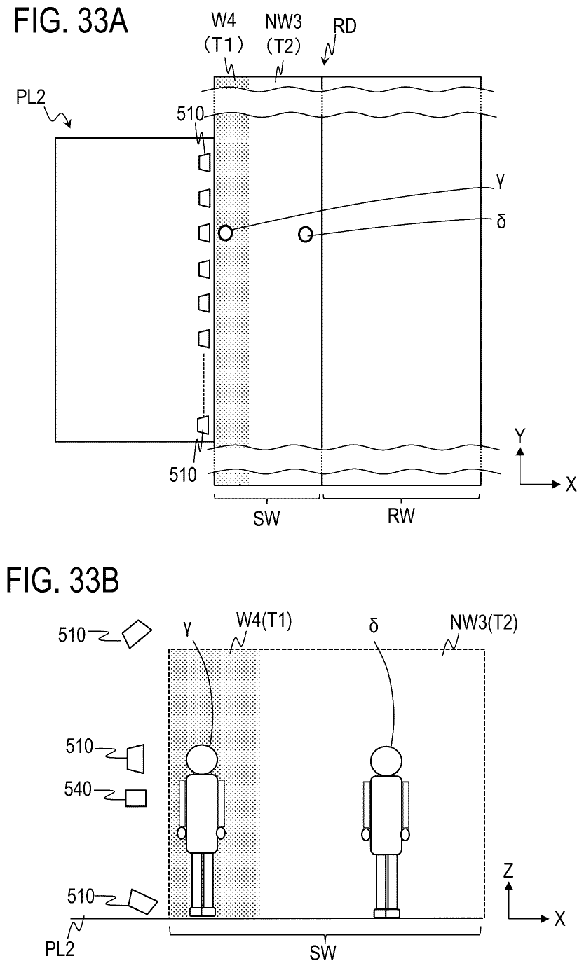

As another application example of the predetermined area PL, there is a construction site PL2 on a roadside as illustrated in FIGS. 33A and 33B. It is assumed that this construction site PL2 is a place along a road RD having a roadway RW and a sidewalk SW. In this case, it is assumed that the sidewalk SW is a dangerous place where, for example, a tool or the like related to construction may fall from above. The sidewalk SW includes a warning area W4 corresponding to the first area T1 for indicating a warning that the construction site PL2 is a dangerous place or the like, and a non-warning area NW3 corresponding to the second area T2 that is an area adjacent to the first area T1 and having a lower necessity for indicating a warning than the first area T1. In FIGS. 33A and 33B, a dot pattern is added to the first area T1. In this example, in the area of the sidewalk SW, it is assumed that an area not provided with the dot pattern is the second area T2. Therefore, in these drawings, a user γ is present in the warning area W4, and a user δ is present in the non-warning area NW3.

In the second application example, the plurality of sound signal output apparatuses 510 is disposed along the vicinity of the warning area W4 of the sidewalk SW. For example, as illustrated in FIG. 33B, the sound signal output apparatus 510 is disposed from a position near the road surface of the sidewalk SW on the ground in the construction site PL2 to face a position (upward direction side) corresponding to the head of the user γ present in the warning area W4. Alternatively, as illustrated in the drawing, the apparatus is disposed from a position at a predetermined height in the construction site PL2 and higher than the head of a human who is a pedestrian to face a position (downward direction side) corresponding to the head of the user γ present in the warning area W4. Alternatively, as illustrated in the drawing, the apparatus is disposed from a position near the head of the user γ in the construction site PL2 to face a position (substantially horizontal direction) corresponding to the head of the user γ present in the warning area W4. However, these are examples, and the arrangement position is not limited thereto.

Regarding the arrangement position of the sensing unit 540, for example, in FIG. 33B, the sensing unit 540 is disposed at a position slightly lower than the head of a human, but the installation position is not limited thereto. For example, a higher position or a lower position may be used. As the number of the sensing units 540 to be disposed, one sensing unit 540 may be disposed with respect to an area that one sound signal output apparatus 510 is in charge of. Alternatively, from the viewpoint of efficiency, a single sensing unit 540 may be configured to be able to cope with an area that the plurality of sound signal output apparatuses 510 is in charge of. Alternatively, for improvement of sensing accuracy, a plurality of sensing units 540 may be configured to cope with an area that one sound signal output apparatus 510 is in charge of.

### <Configuration Regarding Arrangement of Sound Signal Output Apparatus 510>

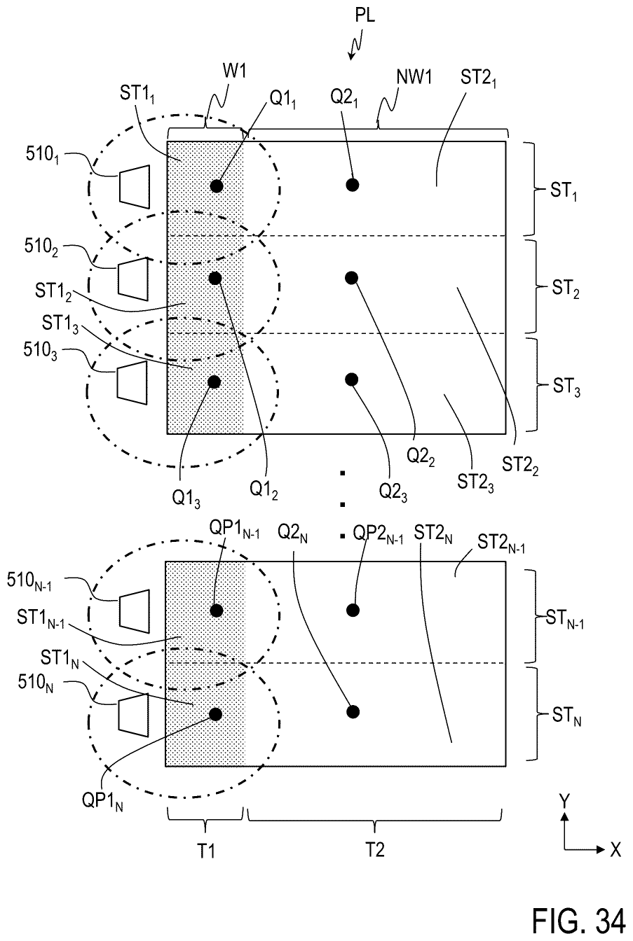

In the sound signal output system 500 of the present embodiment, when determining the configuration related to the arrangement such as the number, shape, size, arrangement interval, and the like of the sound signal output apparatuses 510, in addition to the configuration related to the design specifications of the sound signal output apparatuses 510 to be described below, an area that each sound signal output apparatus 510 is in charge of is considered. Here, for the sake of description, a case where the shape of the predetermined area PL is simplified and the simplified predetermined area PL is divided into N (N≥2) sub-areas STₙ (n=1, 2, . . . , N) as illustrated in FIG. 34 will be described as an example. As illustrated in FIG. 34, each sub-area STₙ includes a first sub-area ST1ₙ (n=1, 2, . . . , N) that is an area within the first area T1, and a second sub-area ST2ₙ (n=1, 2, . . . , N) that is adjacent to the first sub-area ST1ₙ and is an area within the second area T2. That is, the sub-area ST₁ includes a first sub-area ST1₁ and a second sub-area ST2₁. The sub-area ST₂ includes a first sub-area ST1₂ and a second sub-area ST2₂. Similarly, the sub-area ST_{N} includes a first sub-area ST1_{N} and a second sub-area ST2_{N}. Note that dividing into N sub-areas ST is not necessarily limited to dividing into N equal parts, and the size of each sub-area ST may be appropriately adjusted in consideration of the shape of the predetermined area PL, the installation situation of the sound signal output system 500, and the like.

In the example of FIG. 34, it is assumed that different sub-areas ST, are allocated to the sound signal output apparatuses 510, as the areas in charge. Specifically, for the sound signal output apparatus 510₁, the sub-area ST₁ is allocated as an area in charge. For the sound signal output apparatus 510₂, the sub-area ST₂ is allocated as an area in charge. Similarly, for the sound signal output apparatus 510_{N}, the sub-area ST_{N} is allocated as an area in charge. This allocation determines the minimum required number of sound signal output apparatuses 510. For example, as illustrated in FIGS. 32A and 33B, in a case where the sound signal output apparatus 510 is disposed in the vicinity of the railroad track R1 and one sound signal output apparatus 510 is disposed for each area in charge, it is necessary to prepare N sound signal output apparatuses 510. In addition, as illustrated in the drawings, in a case where one sound signal output apparatus 510 is disposed not only in the vicinity of the railroad track R1 but also on the ceiling for each area in charge, N×2 sound signal output apparatuses 510 in total are required at a minimum.

In determining the design specifications of each sound signal output apparatus 510, each of the sound signal output apparatus 510, determines a first point Q1ₙ (n=1, 2, . . . , N) as a representative point for each first sub-area ST1ₙ in charge as illustrated in FIG. 34. In addition, a second point Q2ₙ (n=1, 2, . . . , N) as a representative point is determined for each second sub-area ST2ₙ in charge. Here, the first point Q1 is a representative position of a position where a sound signal is to be listened to, and the second point Q2 is a representative position of a position where the sound signal is not planned to be listened to. In FIG. 34, the sound signal output apparatus 510₁ determines a first point Q11 in the first sub-area ST1₁ and a second point Q21 in the second sub-area ST2₁ as representative points. The sound signal output apparatus 510₂ sets a first point Q1₂ in the first sub-area ST1₂ and a second point Q2₂ in the second sub-area ST2₂ as representative points. Similarly, the sound signal output apparatus 510_{N} sets a first point Q1_{N} in the first sub-area ST1_{N} and a second point Q2_{N} in the second sub-area ST2_{N} as representative points. By considering these representative points and the design specifications of the sound signal output apparatus 510 described below and further performing fine adjustment through a reproduction test or the like of the sound signal, the configuration regarding the arrangement of each sound signal output apparatus 510, as the entire sound signal output system 500 is determined. However, the above is merely an example, and the configuration determination method is not limited thereto.

### <Design Specifications of Sound Signal Output Apparatus 510>

As the sound signal output apparatus 510 of the present embodiment, for example, any one of the sound signal output apparatus 10, the sound signal output apparatus 20, and the sound signal output apparatus 30 described in the first to third embodiments is used. At this time, it may be appropriately selected according to the application place or situation. For example, a detailed structure is designed assuming that the position P1 described in each of the sound signal output apparatuses 10, 20, and 30 is regarded as the first point Q1, the position P2 is regarded as the second point Q2, and the reflector 13 and the axis A1 are disposed toward the first point Q1. Detailed descriptions of the designs of the housings (12, 16, and 36), the reflector 13, the sound holes (131b, 161a, and 163a), and the like described in the first to third embodiments are redundant descriptions, and thus descriptions are omitted. However, the attenuation rates η₁₁ and η₁₁₂ and the attenuation rates η₁₂ and η₁₂₂ in the relationship with the first point Q1 and the second point Q2 are configured as the entire sound signal output system 500 with reference to the design specifications described below.

For example, in the case of the sound signal output apparatus 510 including the driver unit 11 described in the first to third embodiments, the description will be as described below with reference to FIG. 34. In each sound signal output apparatus 510, in a case where the predetermined area PL includes a plurality of sub-areas STₙ including the first sub-area ST1 of the first area T1 and the second sub-area ST2 of the second area T2 adjacent to the first sub-area ST1, mutually different sub-areas ST, are allocated. The concave reflector 13 that has a rotational paraboloid or a surface approximate to the rotational paraboloid inside, and the driver unit 11 that is disposed inside the reflector 13 are included. The sound signal AC1 emitted from the driver unit 11 to one side (D1 side) is set as a first sound signal, and the sound signal AC2 emitted from the driver unit 11 to the other side (D2 side) is set as a second sound signal. In this case, in a case where the first sound signal (AC1) is emitted from one side (D1 side) of the driver unit 11 and the second sound signal (AC2) is emitted from the other side (D2 side) of the driver unit 11, the attenuation rate η₁₁ of the first sound signal (AC1) at the second point Q2 in the second sub-area ST2 of the allocated sub-area ST that is a point farther from the sound signal output apparatus 510 than the first point Q1 with reference to the first point Q1 in the first sub-area ST1 of the allocated sub-area ST that is a predetermined point where the first sound signal (AC1) reaches is designed to be less than or equal to a predetermined value ηₜₕ smaller than the attenuation rate η₂₁ of the sound signal due to air propagation at the second point Q2 with reference to the first point Q1. Alternatively, an attenuation amount η₁₂ of the first sound signal (AC1) at the second point Q2 with reference to the first point Q1 is designed to be larger than or equal to a predetermined value ωₜₕ larger than an attenuation amount η₂₂ of the sound signal due to air propagation at the second point Q2 with reference to the first point Q1.

In addition, in a case where the sound signal output apparatus 510 further includes, for example, the driver unit 15 and the housing 16 accommodating the driver unit 15 therein, and the housing 16 is disposed outside the reflector 13, the configuration described below is obtained. The sound signal AC3 emitted from the driver unit 15 to one side (D1 side) is set as a third sound signal, and the sound signal AC4 emitted from the driver unit 15 to the other side (D2 side) is set as a fourth sound signal. A wall portion of the housing 16 includes a single or plurality of sound 161a (third sound holes) for leading out the third sound signal (AC3) to the inside of the reflector 13 and a single or plurality of sound 163a (fourth sound holes) for leading out the sound signal AC4 to the outside of the reflector 13. It is designed such that in a case where the sound signal AC1 is emitted from one side (D1 side) of the driver unit 11, the sound signal AC2 is emitted from the other side (D2 side) of the driver unit 11, the sound signal AC3 is emitted from one side (D1 side) of the driver unit 15, and the sound signal AC4 is emitted from the other side (D2 side) of the driver unit 15, an attenuation rate η₁₁₂ of the sound signal AC1 and the sound signal AC3 at the second point Q2 with reference to the first point Q1 is equal to or less than a predetermined value ηₜₕ smaller than an attenuation rate η₂₁ of the sound signal due to air propagation at the second point Q2 with reference to the first point Q1. Alternatively, an attenuation amount η₁₂₂ of the sound signal AC1 and the sound signal AC3 at the second point Q2 with reference to the first point Q1 is designed to be larger than or equal to a predetermined value ωₜₕ larger than an attenuation amount η₂₂ of the sound signal due to air propagation at the second point Q2 with reference to the first point Q1.

By configuring the entire sound signal output system 500 as described above, sound leakage to the surroundings can be prevented. That is, when described with reference to FIG. 34, it is possible to suppress sound leakage to an area other than a specific vicinity, such as an area where it is difficult or impossible for a human present in the second area T2ₙ such as the second point Q2ₙ to listen to, although the sound is transmitted to the human present in the first area T1ₙ such as the first point Q1ₙ, and thus, it is possible to cause only a subject who is desired to take a predetermined action such as moving to the outside of the dangerous area to listen to a predetermined sound signal. In addition, since sound leakage to the surroundings can be suppressed, when the sound can be heard only in a predetermined vicinity, for example, in the case of application to the construction site PL2 or the like, even when a sound signal is emitted at night, a noise problem to neighboring residents or the like is less likely to occur. Further, since sound leakage to an area other than a specific vicinity can be suppressed, it is sufficient to dispose only an appropriate number of sound signal output apparatuses 510 without preparing a large number of narrow directional speakers, and therefore, for example, in the case of the railway station PL1, it is possible to efficiently construct the entire system in a large station or the like having a plurality of large platforms.

The sound signal output system 500 may have first to fourth optional functions described below.

### First Optional Function

The control unit 520 may control the sound signal emitted from each sound signal output apparatus 510, to a sound signal having a predetermined frequency (first frequency) or less, such as 1000 Hz or less, and cause the sound signal to be emitted. As described above, since relatively low frequency components easily cancel out each other, by having this optional function, it is possible to transmit a warning sound by further narrowing down a predetermined area. In FIG. 34, an image diagram in a case where the sound signal is transmitted to the vicinity of the first point Q1 is illustrated in elliptical shapes using an alternate long and short dash line. Here, effects such as interference between sounds are ignored. By having this function, this area having an elliptical shape can be further narrowed down. That is, the warning content can be transmitted only to the person who is present at the first point Q1ₙ that is the representative point or in the vicinity thereof.

### Second Optional Function

The control unit 520 may cause each sound signal output apparatus 510 to emit a sound signal at a predetermined time or time zone. That is, in a case where it is not a predetermined time or time zone, the warning may be reserved. Taking the above-described railway station PL1 as an example, by adopting such a configuration, the predetermined warning can be performed only within the business hours, for example.

### Third Optional Function

In a case where the sensing unit 540 is provided, in a case where the sensing unit 540 senses that a human is present at any point in the first area T1, the control unit 520 may be configured to cause only a sound signal output apparatus 510ₓ to which a sub-area (this is referred to as a “sub-area STₓ”) where a point where the human is present is allocated to emit a sound signal, or to cause only predetermined sound signal output apparatuses 510 such as including sound signal output apparatuses 510ₓ₋₁ and 510ₓ₊₁ on both sides thereof to emit a sound signal. It is possible to promote the efficiency of the sound signal output system 500 in that the sound signal is not emitted to an area where the effect is small.

### Fourth Optional Function

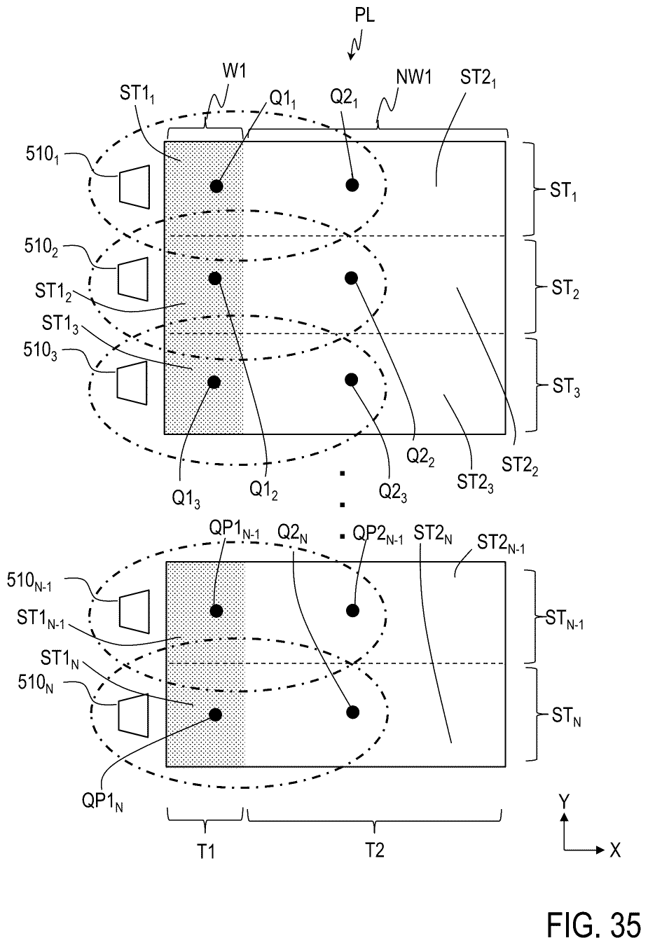

For example, in the first application example, in the railway station PL1, a case where it is preferable to notify not only the human present in the first area T1 but also the human present in the second area T2, or a case where they should be notified of, such as in-premises announcement or BGM indicating that a train delay has occurred, is also assumed. In FIG. 35, an image diagram in a case where the sound signal is transmitted not only to the first point Q1 but also to the second point Q2 is illustrated in elliptical shapes using an alternate long and short dash line. Here, effects such as interference of sounds are ignored. Also in this drawing, effects such as interference between sounds are ignored. In such a case, the control unit 520 may emit the sound signal emitted from each sound signal output apparatus 510, as a sound signal having a predetermined frequency (second frequency) or higher, such as 3000 Hz or higher. As described above, since it is difficult for the high-frequency sound signals to cancel out each other, for example, it is possible to transmit information to a human present at the second point Q2. By having this optional function, it is possible to provide a system that can flexibly cope with a situation in that not only a warning to a nearby person but also necessary information can be transmitted to a person (human) in need.

Note that, for example, in a case where this method is configured by the sound signal output apparatus 510 including the driver unit 11 and the driver unit 15, a frequency band of 1000 Hz or less may be configured to be emitted from the driver unit 15, and a frequency band of 3000 Hz or more may be configured to be emitted from the driver unit 11.

### <Processing Flow>

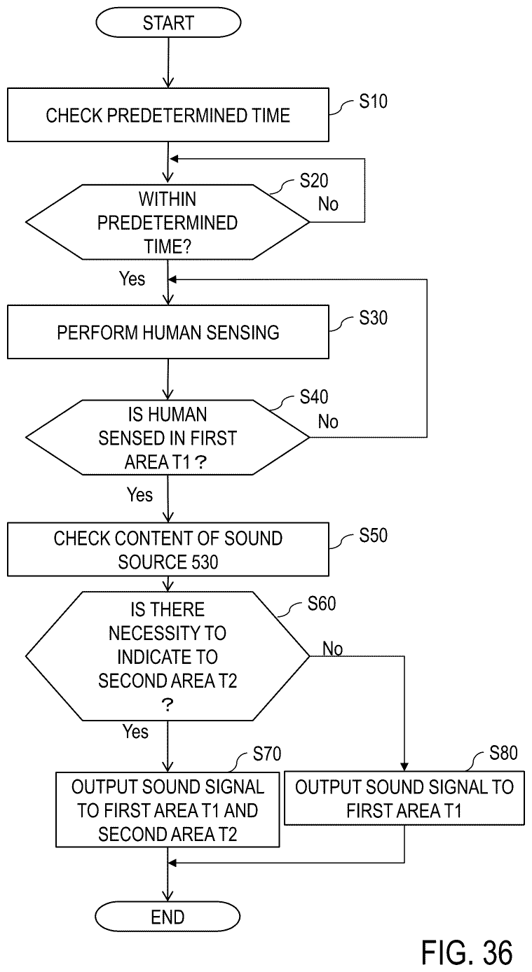

FIG. 36 is a diagram illustrating a processing flow example of the sound signal output system according to the fourth embodiment described above. The sound signal output system 500 having the first to fourth optional functions described above performs the sound signal output method of the present embodiment by performing the processing flow illustrated in FIG. 36.

The control unit 520 checks the predetermined time (step S10). That is, the control unit 520 checks information of the drive time or the drive time zone set in a memory, which is not illustrated. If the current time is not within the predetermined time (No in step S20), the control unit 520 reserves subsequent processing until reaching the predetermined time. If the current time is within the predetermined time (Yes in step S20), the control unit 520 starts execution of human sensing using the sensing unit 540 (step S30). If the sensing unit 540 does not sense a human in the first area T1ₙ (No in step S40), the subsequent processing is reserved until the human is sensed. If the sensing unit 540 senses a human in the first area T1ₙ (Yes in step S40), the control unit 520 checks the content of the sound signal of the sound source 530 to be indicated (step S50). As a result, if the content of the sound signal to be indicated does not need to be indicated to a human present in the second area T2ₙ (No in step S60), the control unit 520 follows the design specifications of the sound signal output apparatus 510 and delivers the sound signal to the area outside the first area T1 so as to suppress sound leakage (step S80). In this case, the control unit 520 causes the sound signal output apparatus 510ₙ to emit a pre-designed sound signal (warning sound) having a frequency less than the first frequency described above, for example, 1000 Hz, or in a case where an existing sound signal is reproduced, the sound signal is emitted after signal processing with a low-pass filter is performed so that the sound signal is reproduced at 1000 Hz or less, for example. If the content of the sound signal to be indicated needs to be indicated to a human present in the second area T2ₙ (Yes in step S60), the control unit 520 follows the design specifications of the sound signal output apparatus 510 and delivers the sound signal so as to be transmitted to the first area T1 and the second area T2, but to suppress sound leakage to the other areas (step S70). In this case, the control unit 520 causes the sound signal output apparatus 510ₙ to emit a sound signal designed in advance to the first frequency or more described above, for example, 3000 Hz or more, or in a case where an existing sound signal is reproduced, the sound signal is emitted after signal processing with a high-pass filter is performed so that the sound signal is reproduced at 3000 Hz or more, for example. Note that, in the processing of steps S70 and S80, only the predetermined sound signal output apparatus 510 may emit the sound signal, for example, only the sound signal output apparatus 510 in charge of the first sub-area ST1 in which the human is sensed in the processing of step S30 may emit the sound signal. In addition, the signal processing with the low-pass filter or the high-pass filter may be configured to be performed by the control unit 520, may be configured to be performed by the sound signal output apparatus 510ₙ, or may be performed by providing a dedicated processing unit.

Note that, in a case where the first optional function described above is unnecessary, it is sufficient if the control unit 520 omits the processing of steps S50 to S80 and causes the sound signal to be emitted on the basis of the specifications of the sound signal output apparatus 510, designed without controlling the frequency. In a case where the second optional function is unnecessary, it is sufficient if the control unit 520 omits the processing of steps S10 to S20. In a case where the third optional function is unnecessary, it is sufficient if the control unit 520 omits the processing of steps S30 to S40. In a case where the processing of step S30 is omitted, the processing of causing only the predetermined sound signal output apparatus 510 to emit the sound signal described in step S80 is also omitted. In a case where the fourth optional function is unnecessary, it is sufficient if the control unit 520 omits the processing of steps S50 to S80 and causes the sound signal to be emitted on the basis of the specifications of the sound signal output apparatus 510, designed without controlling the frequency, and the control unit 520 does not limit the sound signal output apparatus 510.

The sound signal output system 500 according to the fourth embodiment described above can prevent sound leakage to the surroundings, and can cause only a subject who is desired to take a predetermined action to listen to a predetermined sound signal.

### Fifth Embodiment

### Overall Configuration

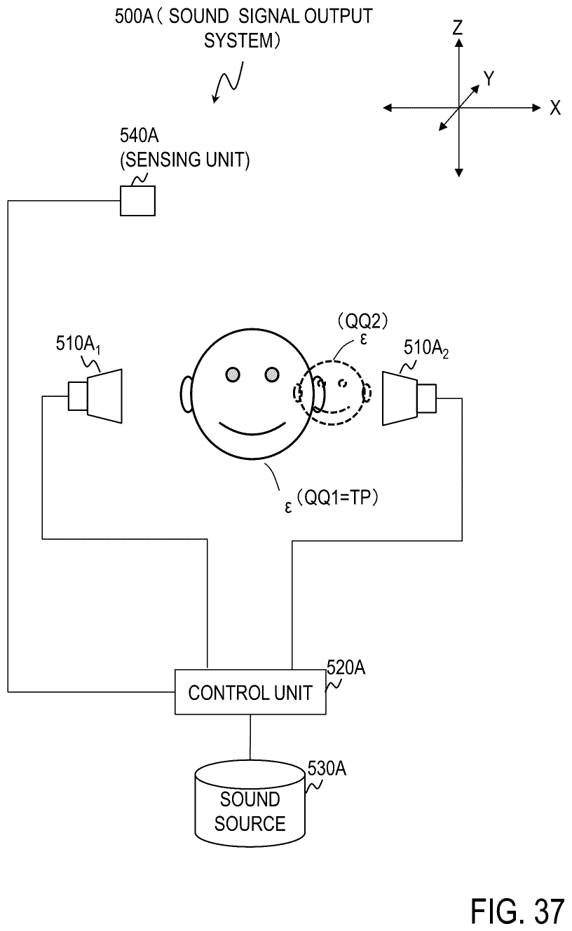

Hereinafter, another sound signal output system according to an embodiment of the present invention will be described as a fifth embodiment. A sound signal output system 500A according to the present embodiment is a sound signal output system used by a user to listen to a sound signal. In other words, it is a sound signal output system used to actively listen to the sound signal on the basis of the intention of the user as a main purpose. As illustrated in FIG. 37, the sound signal output system 500A includes sound signal output apparatuses 510A, a control unit 520A, a sound source 530A, and a sensing unit 540A.

The sound signal output apparatus 510A is to emit (output) a sound signal. At least one sound signal output apparatus 510A is provided. In FIG. 37, two sound signal output apparatuses (510A₁ and 510A₂) are provided. The sound signal output apparatus 510A is disposed at a position in the vicinity of a guide destination position TP that is an ideal position for listening to the sound signal, where the emitted sound signal can be emitted toward the guide destination position TP. In other words, the guide destination position TP is a position where the sound signal can be well listened to. That is, it is a position (hereinafter, also referred to as a “sweet spot”) at which the service provider of the sound signal output system 500A wants the user to move the head to the position.

The control unit 520A manages processing of the entire system. For example, as one function, the emission by the sound signal output apparatus 510A is controlled using the sound source 530A for causing the user to listen.

The sound source 530A is a sound source of a sound signal for causing the user to listen, and is, for example, content such as music or moving image audio, or sound signal data such as giving a predetermined instruction, but the type of data is not limited thereto. In addition, the sound signal data is not necessarily prepared in advance, and may be configured to be input to the sound signal output system 500A via a predetermined microphone and emitted in real time.

The sensing unit 540A senses that a human is present in a predetermined area. The sensing unit 540A includes, for example, a human sensor or an imaging apparatus such as a camera, but is not limited thereto. The accuracy of the sensing unit 540A is preferably higher than that of the sensing unit 540 of the fourth embodiment, for example, a slight movement of a human can be accurately sensed. For example, in a case where the user sits on a chair, it is preferable that the sensing unit 540A can sense or detect the position with predetermined high accuracy in a range where the position of the head of the user moves. That is, even in a case where the head of the human is in the vicinity of the guide destination position TP but is present at a position deviated from the guide destination position TP, which is the sweet spot, it is preferable to secure accuracy to the extent that the position of the head of the human can be detected within a predetermined range (within a predetermined area), such as the position can be detected with predetermined accuracy. In the case of the sensing unit 540A with higher accuracy, the position of the ear of the human may be sensed with higher accuracy. In that case, the entire sound signal output system 500A may be configured to guide the position of the ear to the position of the guide destination position TP. The number of the sensing units 540A is adjusted to M (M≥1) so as to be able to cope with a predetermined area to be measured. Although one sensing unit 540A is provided in FIG. 37, a plurality of sensing units 540A may be provided to configure the sound signal output system 500A in order to ensure high accuracy. Note that the sensing unit 540A is not an essential component. When no sensing function is necessary in the sound signal output system 500A, the sensing unit 540A may not be provided.

### Application Example

The present embodiment is a sound signal output system used by a user to listen to a sound signal, and examples of a predetermined area PL′ that is a use place include seats in a movie theater, an airplane, a train, and the like, and use by being a lying posture such as a supine position, a lateral position, a prone position, an abdominal position, and the like as well as a standing posture and an oblique posture in an attraction in an amusement park as long as a sound is heard in a place where a similar posture is kept for a certain period of time. However, the predetermined area PL′ is not limited thereto.

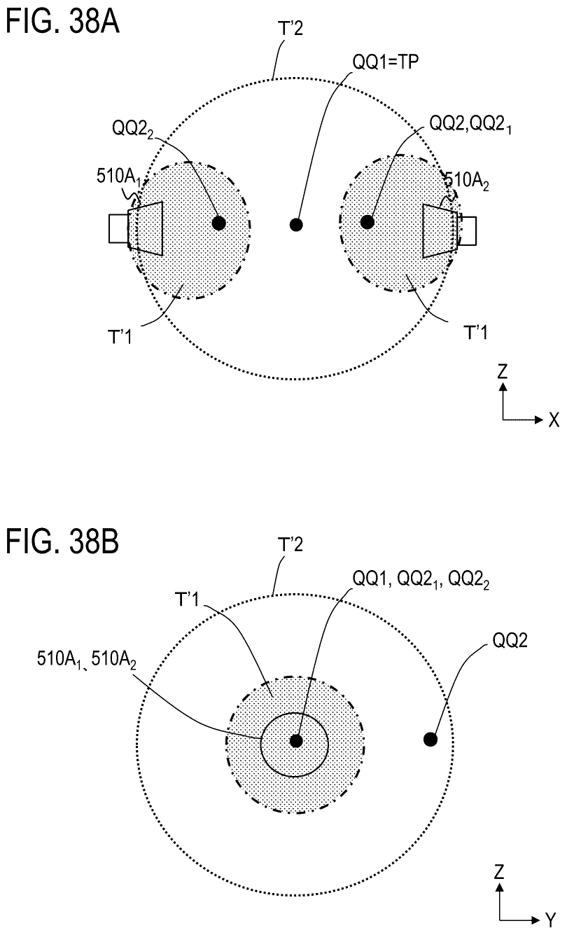

In FIG. 37, the sound signal output apparatus 510A emits, from the sound signal output apparatus 510, a sound signal to be listened to by using the sound source 530A to a user ε sitting on a predetermined seat (not illustrated) and present in a predetermined area PL′ (not illustrated). In this case, the user c, who is a human having the head at a second point QQ2 (coordinate position (X₂, Y₂, Z₂)) in an area to be sensed by the sensing unit 540A, which is the area different from a first area T′1 (hereinafter, these ranges are also referred to as “second area T′2”) with reference to a predetermined range, which is an area to be sensed by the sensing unit 540A and at the guide destination position TP, which is the sweet spot, or a position extremely close to the guide destination position TP (hereinafter, these ranges are also referred to as “first area T′1”), is moved to a first point QQ1 (coordinate position (X₁, Y₁, Z₁)) of the guide destination position TP, which is the sweet spot, or a position extremely close thereto, so that the user ε can clearly listen to the sound signal of the sound source 530A (in FIGS. 38A and 38B, the outer edges of the first areas T′1 are indicated by alternate long and short dash lines, and a dot pattern is added to the inside of the areas. In addition, the outer edge of the second area T′2 is indicated by a dotted line). As a result, it is possible to guide a person (human) present at the second point QQ2 in an area where it is impossible to hear a target sound signal or it is difficult to hear the target sound signal as compared with the guide destination position TP to move to the first point QQ1 of the guide destination position TP, which is the sweet spot. That is, for example, in the description using the example of FIG. 38A, the head is guided to move to the area where the sound signals of both the sound signal output apparatus 510A₁ and the sound signal output apparatus 510A₂ can be clearly heard using the fact that a sound other than a sound in the vicinity of the speaker is suppressed. However, this guide method is merely an example, and depending on the configuration of the sound signal output system 500A, guide may be performed to a position where the sound signal of one sound signal output apparatus 510A can be clearly heard. In addition, in a case where the sound signal output system 500A includes three or more sound signal output apparatuses 510A, it may be configured such that guide to the position where the sound signals from one or more predetermined sound signal output apparatuses 510A can be clearly heard is performed.

### <Design Specifications of Sound Signal Output Apparatus 510A>

As the sound signal output apparatus 510A of the present embodiment, for example, any one of the sound signal output apparatus 10, the sound signal output apparatus 20, and the sound signal output apparatus 30 described in the first to third embodiments is used. At this time, it may be appropriately selected according to the application place or situation. For example, it is designed assuming that the position P1 described in each of the sound signal output apparatuses 10, 20, and 30 is regarded as the first point QQ1, the position P2 is regarded as the second point QQ2, and the reflector 13 and the axis A1 are disposed to face the first point QQ1. Detailed descriptions of the designs of the housings (12, 16, and 36), the reflector 13, the sound holes (131b, 161a, and 163a), and the like described in the first to third embodiments are redundant descriptions, and thus descriptions are omitted. However, the attenuation rates η₁₁, and η₁₁₂ and the attenuation rates η₁₂ and η₁₂₂ in the relationship with the first point QQ1 and the second point QQ2 are configured as the entire sound signal output system 500A with reference to the design specifications described below.

For example, in the case of the sound signal output apparatus 510A including the driver unit 11 described in the first to third embodiments, the description will be as described below. Each sound signal output apparatus 510A includes the concave reflector 13 that has a rotational paraboloid or a surface approximate to the rotational paraboloid inside and the driver unit 11 that is disposed inside the reflector 13. The sound signal AC1 using the sound source emitted from the driver unit 11 to one side (D1 side) is set as a first sound signal, and the sound signal AC2 emitted from the driver unit 11 to the other side (D2 side) is set as a second sound signal. The case is considered in which the sound signal output apparatus 510A emits the first sound signal (AC1) to one side (D1 side) of the driver unit 11 and emits the second sound signal (AC2) to the other side (D2 side) of the driver unit 11. In this case, the attenuation rate η₁₁ of the first sound signal (AC1) at the second point QQ2 (second point QQ2₁ for the sound signal output apparatus 510A₁ and the second point QQ2₂ for the sound signal output apparatus 510A₂; the same applies hereinafter), which is a point farther from the sound signal output apparatus 510A than the first point QQ1 with reference to the first point QQ1 (FIG. 38), which is the predetermined guide destination position TP where the first sound signal (AC1) reaches, is configured to be less than or equal to a predetermined value ηₜₕ smaller than an attenuation rate η₂₁ of the sound signal due to air propagation at the second point QQ2 with reference to the first point QQ1. Alternatively, an attenuation amount η₁₂ of the first sound signal (AC1) at the second point QQ2 with reference to the first point QQ1 is configured to be larger than or equal to a predetermined value ωₜₕ larger than an attenuation amount η₂₂ of the sound signal due to air propagation at the second point QQ2 with reference to the first point QQ1.

In addition, in a case where the sound signal output apparatus 510A further includes, for example, the driver unit 15 and the housing 16 accommodating the driver unit 15 therein, and the housing 16 is disposed outside the reflector 13, the configuration described below is obtained. The sound signal AC3 emitted from the driver unit 15 to one side (D1 side) is set as a third sound signal, and the sound signal AC4 emitted from the driver unit 15 to the other side (D2 side) is set as a fourth sound signal. A wall portion of the housing 16 includes a single or plurality of sound 161a (third sound holes) for leading out the third sound signal (AC3) to the inside of the reflector 13 and a single or plurality of sound 163a (fourth sound holes) for leading out the sound signal AC4 to the outside of the reflector 13. It is designed such that in a case where the sound signal AC1 is emitted from one side (D1 side) of the driver unit 11, the sound signal AC2 is emitted from the other side (D2 side) of the driver unit 11, the sound signal AC3 is emitted from one side (D1 side) of the driver unit 15, and the sound signal AC4 is emitted from the other side (D2 side) of the driver unit 15, an attenuation rate η₁₁₂ of the sound signal AC1 and the sound signal AC3 at the second point QQ2 with reference to the first point QQ1 is equal to or less than a predetermined value ηₜₕ smaller than an attenuation rate η₂₁ of the sound signal due to air propagation at the second point QQ2 with reference to the first point QQ1. Alternatively, an attenuation amount η₁₂₂ of the sound signal AC1 and the sound signal AC3 at the second point QQ2 with reference to the first point QQ1 is designed to be larger than or equal to a predetermined value ωₜₕ larger than an attenuation amount η₂₂ of the sound signal due to air propagation at the second point QQ2 with reference to the first point QQ1.

By configuring the entire sound signal output system 500A as described above, sound leakage to the surroundings can be prevented. That is, in the case of being present in a very limited first area T′1 in the vicinity of the guide destination position TP including the first point QQ1 (strictly speaking, “present” in this case means that the user's ear is in the area), it is possible to listen to, but in the case of being present in a second area T′2 such as the second point QQ2, it is difficult or impossible to listen to. The predetermined area PL′ is a place intended to actively listen to the sound signal on the basis of the intention of the user. By notifying the user in advance that it is easy to listen to the sound signal clearly in the sweet spot, in a case where the user cannot listen to the sound signal, it is recognized that the place where the head is present at that time point is not the sweet spot. As a result, the movement of the head of the user can be urged. That is, since the sound signal output system 500A can suppress sound leakage to a portion other than a specific vicinity, it is possible to urge the subject who is desired to take an action and present in the second area T′2 to move.

### <Processing Flow 1>

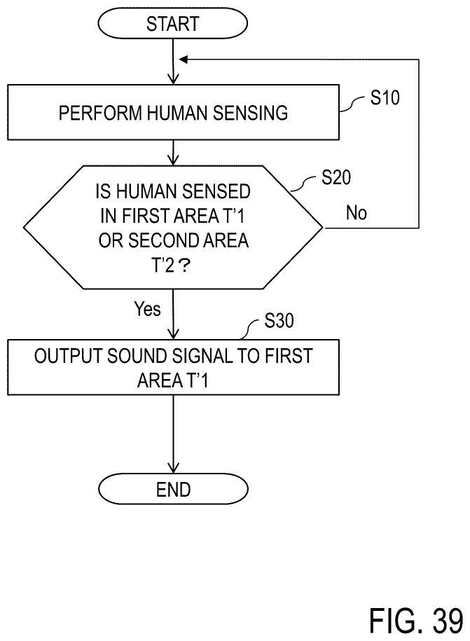

FIG. 39 is a diagram illustrating a processing flow example of the sound signal output system according to the fifth embodiment. The sound signal output system 500A described above performs the sound signal output method of the present embodiment by performing the processing flow illustrated in FIG. 39.

The control unit 520A starts execution of human sensing using the sensing unit 540A (step S10).

If the sensing unit 540A does not sense a human either in the first area T′1 or the second area T′2, which is a sensing area (No in step S20), the subsequent processing is reserved until the human is sensed. If the sensing unit 540A senses a human in either the first area T′1 or the second area T′2 (Yes in step S20), the control unit 520A follows the design specifications of the sound signal output apparatus 510A and delivers a sound signal to an area outside the first area T′1 so as to suppress sound leakage (step S30). Note that, in this case, processing for causing the sound signal output apparatus 510A to emit a sound signal at a frequency less than a predetermined frequency (first frequency) may be performed. In this case, as described above, since the attenuation amount of the sound signal of 1000 Hz or less is large, in the above-described application case, it is preferable to flow the sound signal in a range of 200 Hz to 1000 Hz, for example, as the first frequency.

With the configuration as described above, the user who is desired to take a predetermined action is moved to the guide destination position TP, so that only the user can listen to a predetermined sound signal.

Note that the sound signal output system 500A itself may be used as a suppression sound reproduction speaker for noise cancellation because the sound signal output system 500A has an effect of suppressing sound leakage to an area outside a predetermined vicinity.

Note that, in a case where the function of sensing a human is unnecessary, it is sufficient if the processing of steps S10 and S20 in FIG. 39 is omitted.

### <Processing Flow 2>

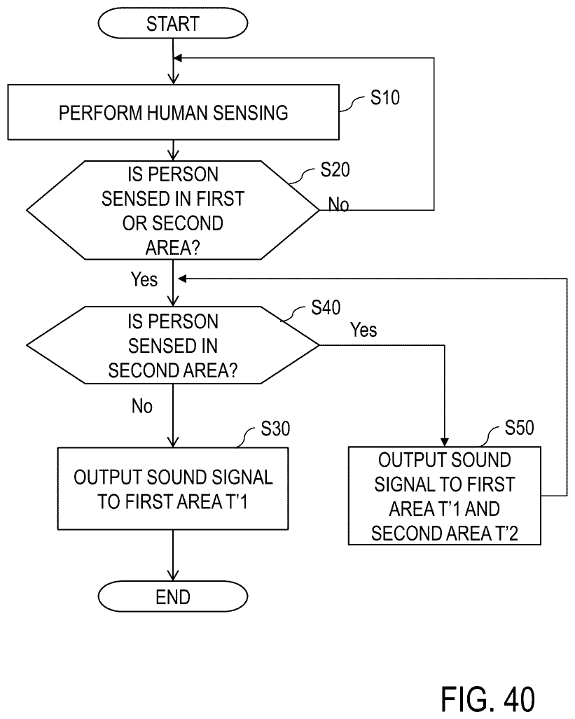

FIG. 40 is a diagram illustrating another processing flow example of the sound signal output system according to the fifth embodiment. FIG. 40 is a flow for causing the user c to listen to a sound signal (guide sound) of contents urging the user ε to move to the guide destination position TP in order to urge the user ε to move to the first point QQ1, which is the guide destination position TP, when the user ε is present in an area in the second area T′2. In FIG. 40, steps S40 and S50 are added to the flow of FIG. 39, and thus the description of steps S10 to S30 is omitted.

In FIG. 40, if the sound signal output system 500A senses that the user ε is present in the second area T′2 (Yes in step S40), the control unit 520A follows the design specifications of the sound signal output apparatus 510A and delivers the sound signal (guide sound) so as to be transmitted to the first area T′1 and the second area T′2, but to suppress sound leakage to the other areas (step S50). Note that, in this case, processing for causing the sound signal output apparatus 510A to emit a guide sound with a sound signal of the first frequency or higher may be performed. Note that this frequency is determined in consideration of the place of the predetermined area PL′, the range sensed by the sensing unit 540A, and the like.

If the sound signal output system 500A does not sense that the user ε is present in the second area T′2 (No in step S40), in this case, since the processing of step S20 has already been performed, the user ε is present in the first area T′1, and the processing of step S30 described above is performed.

For example, in a case where the sound signal output system 500A includes the driver unit 11 and the driver unit 15, it may be configured such that a frequency band less than the first frequency is emitted from the driver unit 15 and a frequency band equal to or higher than the first frequency is emitted from the driver unit 11.

The sound signal output system 500A according to the fifth embodiment described above can prevent sound leakage to the surroundings and cause the user who is desired to take a predetermined action to move to the guide destination position TP, so that only the user can listen to a sound signal.

While the embodiments and the modification examples of the present invention have been described above, a specific configuration is not limited to the embodiments and the modification examples, and it goes without saying that an appropriate design change or the like not departing from the gist of the present disclosure is included in the present disclosure. For example, although it has been described that the control units 520 and 520A manage processing of the entire system, each processing may be configured to be performed by another component. In addition, the various types of processing described in the embodiments and the modification examples may be executed not only in chronological order in accordance with the described order, but also in parallel or individually depending on the processing capability of an apparatus that executes the processing or as necessary.

### REFERENCE SIGNS LIST

10, 20, 30 Sound signal output apparatus
11, 15, 35 Driver unit
12, 16, 36 Housing
13 Reflector
101a High-pass filter
101b Low-pass filter
113, 153, 353 Diaphragm
130 Open end
131a Bottom portion
131b, 161a, 163a Sound hole
231b Cutout portion
500, 500A Sound signal output system
510, 510A Sound signal output apparatus
520, 520A Control unit
530, 530A Sound source
540, 540A Sensing unit
H1, H2 Platform
NW1, NW2, NW3 Non-warning area
PL, PL′ Predetermined area
PL1 Railway station
PL2 Construction site
R1, R2 Railroad track
RW Roadway
SW Sidewalk
ST Sub-area
ST1 First sub-area
ST2 Second sub-area
T1, T′1 First area
T2, T′2 Second area
W1, W2, W3, W4 Warning area
α, ζ, ε User
γ, δ Pedestrian

1. A sound signal output system for use in a predetermined area including a first area for indicating a warning and a second area adjacent to the first area and having a lower necessity for indicating the warning than the first area, the sound signal output system comprising:
a plurality of sound signal output apparatuses that is disposed in the first area or in a vicinity of the first area and emits a sound signal; and
a controller that controls emission by the plurality of sound signal output apparatuses using a sound source corresponding to the warning,
wherein
each of the sound signal output apparatuses
is allocated with a different sub-area in a case where the predetermined area includes a plurality of sub-areas including a first sub-area in the first area and a second sub-area adjacent to the first sub-area and in the second area, and
includes
a concave reflector that has a rotational paraboloid or a surface approximate to the rotational paraboloid inside, and
a first driver that is disposed inside the reflector,
a sound signal emitted from the first driver to one side is set as a first sound signal, and a sound signal emitted from the first driver to an other side is set as a second sound signal,
when the first sound signal is emitted from the one side of the first driver and the second sound signal is emitted from the other side of the first driver, an attenuation rate of the first sound signal at a second point in the second sub-area of the allocated sub-area, the second point being a point farther from the sound signal output apparatus than a first point with reference to the first point in the first sub-area of the allocated sub-area, the first point being a predetermined point where the first sound signal reaches is
configured to be less than or equal to a predetermined value smaller than an attenuation rate of a sound signal due to air propagation at the second point with reference to the first point, or
an attenuation amount of the first sound signal at the second point with reference to the first point is configured to be equal to or more than a predetermined value larger than an attenuation amount of the sound signal due to air propagation at the second point with reference to the first point.

2. The sound signal output system according to claim 1, further comprising:
a sensor that senses that a human is present,
wherein
in a case where the sensor senses that a human is present at any point in the first area, the sound signal output apparatus to which the sub-area where the point where the human is present is located is allocated emits the first sound signal and the second sound signal.

3. The sound signal output system according to claim 1, wherein
each of the sound signal output apparatus further includes
a second driver, and
a second housing that accommodates the second driver therein,
the second housing is disposed outside the reflector,
a sound signal emitted from the second driver to one side is set as a third sound signal, and a sound signal emitted from the second driver to an other side is set as a fourth sound signal,
a wall portion of the second housing is provided with one or a plurality of third sound holes for leading out the third sound signal to an inside of the reflector and one or a plurality of fourth sound holes for leading out the fourth sound signal to an outside of the reflector, and
in a case where the first sound signal is emitted from the one side of the first driver, the second sound signal is emitted from the other side of the first driver, the third sound signal is emitted from the one side of the second driver, and the fourth sound signal is emitted from the other side of the second driver,
an attenuation rate of the first sound signal and the third sound signal at the second point with reference to the first point is
designed to be less than or equal to a predetermined value smaller than an attenuation rate of a sound signal due to air propagation at the second point with reference to the first point, or
an attenuation amount of the first sound signal and the third sound signal at the second point with reference to the first point is designed to be larger than or equal to a predetermined value larger than an attenuation amount of a sound signal due to air propagation at the second point with reference to the first point.

4. A sound signal output system used for a user to listen to a sound signal, the sound signal output system comprising:
at least one sound signal output apparatus that is installed toward a guide destination position and emits the sound signal; and
a controller that controls emission by the sound signal output apparatus,
wherein
the sound signal output apparatus includes
a concave reflector that has a rotational paraboloid or a surface approximate to the rotational paraboloid inside, and
a first driver that is disposed inside the reflector,
a sound signal emitted from the first driver to one side is set as a first sound signal, and a sound signal emitted from the first driver to an other side is set as a second sound signal,
in a case where the first sound signal is emitted from the one side of the first driver and the second sound signal is emitted from the other side of the first driver, an attenuation rate of the first sound signal at a second point that is a point farther from the sound signal output apparatus than a first point with reference to the first point that is a predetermined guide destination where the first sound signal reaches is
configured to be less than or equal to a predetermined value smaller than an attenuation rate of a sound signal due to air propagation at the second point with reference to the first point, or
an attenuation amount of the first sound signal at the second point with reference to the first point is configured to be larger than or equal to a predetermined value larger than an attenuation amount of a sound signal due to air propagation at the second point with reference to the first point.

5. The sound signal output system according to claim 4, wherein
each of the sound signal output apparatus further includes
a second driver, and
a second housing that accommodates the second driver therein,
the second housing is disposed outside the reflector,
a sound signal emitted from the second driver to one side is set as a third sound signal, and a sound signal emitted from the second driver to an other side is set as a fourth sound signal,
a wall portion of the second housing is provided with one or a plurality of third sound holes for leading out the third sound signal to an inside of the reflector and one or a plurality of fourth sound holes for leading out the fourth sound signal to an outside of the reflector, and
in a case where the first sound signal is emitted from the one side of the first driver, the second sound signal is emitted from the other side of the first driver, the third sound signal is emitted from the one side of the second driver, and the fourth sound signal is emitted from the other side of the second driver,
an attenuation rate of the first sound signal and the third sound signal at the second point with reference to the first point is
designed to be less than or equal to a predetermined value smaller than an attenuation rate of a sound signal due to air propagation at the second point with reference to the first point, or
an attenuation amount of the first sound signal and the third sound signal at the second point with reference to the first point is designed to be larger than or equal to a predetermined value larger than an attenuation amount of a sound signal due to air propagation at the second point with reference to the first point.

6. A sound signal output method for use in a predetermined area including a first area for indicating a warning and a second area adjacent to the first area and having a lower necessity for indicating the warning than the first area, the sound signal output method comprising:
disposing a plurality of sound signal output apparatuses that emits a sound signal in the first area or in a vicinity of the first area; and
causing a controller to control emission by the plurality of sound signal output apparatuses using a sound source corresponding to the warning,
wherein
each of the sound signal output apparatuses
is allocated with a different sub-area in a case where the predetermined area includes a plurality of sub-areas including a first sub-area in the first area and a second sub-area adjacent to the first sub-area and in the second area, and
includes
a concave reflector that has a rotational paraboloid or a surface approximate to the rotational paraboloid inside, and
a first driver that is disposed inside the reflector,
a sound signal emitted from the first driver to one side is set as a first sound signal, and a sound signal emitted from the first driver to an other side is set as a second sound signal,
when the first sound signal is emitted from the one side of the first driver and the second sound signal is emitted from the other side of the first driver, an attenuation rate of the first sound signal at a second point in the second sub-area of the allocated sub-area, the second point being a point farther from the sound signal output apparatus than a first point with reference to the first point in the first sub-area of the allocated sub-area, the first point being a predetermined point where the first sound signal reaches is
configured to be less than or equal to a predetermined value smaller than an attenuation rate of a sound signal due to air propagation at the second point with reference to the first point, or
an attenuation amount of the first sound signal at the second point with reference to the first point is configured to be equal to or more than a predetermined value larger than an attenuation amount of the sound signal due to air propagation at the second point with reference to the first point.

7. A sound signal output method used for a user to listen to a sound signal, the sound signal output method comprising:
installing at least one sound signal output apparatus that emits the sound signal toward a guide destination position; and
causing a controller to control emission by the sound signal output apparatus,
wherein
the sound signal output apparatus includes
a concave reflector that has a rotational paraboloid or a surface approximate to the rotational paraboloid inside, and
a first driver that is disposed inside the reflector,
a sound signal emitted from the first driver to one side is set as a first sound signal, and a sound signal emitted from the first driver to an other side is set as a second sound signal,
in a case where the first sound signal is emitted from the one side of the first driver and the second sound signal is emitted from the other side of the first driver, an attenuation rate of the first sound signal at a second point that is a point farther from the sound signal output apparatus than a first point with reference to the first point that is a predetermined guide destination where the first sound signal reaches is
configured to be less than or equal to a predetermined value smaller than an attenuation rate of a sound signal due to air propagation at the second point with reference to the first point, or
an attenuation amount of the first sound signal at the second point with reference to the first point is configured to be larger than or equal to a predetermined value larger than an attenuation amount of a sound signal due to air propagation at the second point with reference to the first point.

8. The sound signal output system according to claim 2, wherein
each of the sound signal output apparatus further includes
a second driver, and
a second housing that accommodates the second driver therein,
the second housing is disposed outside the reflector,
an sound signal emitted from the second driver to one side is set as a third sound signal, and an sound signal emitted from the second driver to an other side is set as a fourth sound signal,
a wall portion of the second housing is provided with one or a plurality of third sound holes for leading out the third sound signal to an inside of the reflector and one or a plurality of fourth sound holes for leading out the fourth sound signal to an outside of the reflector, and
in a case where the first sound signal is emitted from the one side of the first driver, the second sound signal is emitted from the other side of the first driver, the third sound signal is emitted from the one side of the second driver, and the fourth sound signal is emitted from the other side of the second driver,
an attenuation rate of the first sound signal and the third sound signal at the second point with reference to the first point is
designed to be less than or equal to a predetermined value smaller than an attenuation rate of an sound signal due to air propagation at the second point with reference to the first point, or
an attenuation amount of the first sound signal and the third sound signal at the second point with reference to the first point is designed to be larger than or equal to a predetermined value larger than an attenuation amount of an sound signal due to air propagation at the second point with reference to the first point.
